(19) United States
(12) Patent Application Publication
(10) Pub. No.: US 2024/0144413 A1
(43) Pub. Date: May 2, 2024

(54) VIRTUAL TRAVEL SYSTEM, VIRTUAL GATHERING SYSTEM, AND COMMUNICATION TERMINAL

(71) Applicant: Itaru ISHII, Tokyo (JP)

(72) Inventor: Itaru ISHII, Tokyo (JP)

(21) Appl. No.: 18/541,657

(22) Filed: Dec. 15, 2023

Related U.S. Application Data
(63) Continuation of application No. PCT/JP2022/022728, filed on Jun. 6, 2022.

(30) Foreign Application Priority Data
Jun. 15, 2021 (JP) JP2021-099135
Aug. 12, 2021 (JP) JP2021-131546

(51) Int. Cl. G06Q 50/40; G06Q 20/12; G06Q 30/0226; G06Q 30/0601

(52) U.S. Cl. CPC G06Q 50/40; G06Q 20/12; G06Q 30/0643; G06Q 30/0226

(57) ABSTRACT

A virtual travel service system accepts a boarding request for a virtual passenger airplane, which is an example of a virtual vehicle, from a user's communication terminal before the departure time of the virtual passenger airplane and registers the user as a passenger of the virtual passenger airplane. A common boarding experience is provided to a plurality of passengers on the virtual passenger airplane.

### CROSS-REFERENCE TO RELATED APPLICATIONS

This application is a continuation application of International Application No. PCT/JP2022/022728 filed on Jun. 6, 2022, which claims priority to and the benefit of Japanese Patent Application No. 2021-099135 filed on Jun. 15, 2021 and Japanese Patent Application No. 2021-131546 filed on Aug. 12, 2021. The contents of these applications are incorporated herein by reference in their entirety.

### BACKGROUND

### 1. Field

This invention relates to virtual reality technology, in particular, to technology for providing virtual travel or gathering experiences.

### 2. Description of Related Art

The joy of travel is to experience something different from everyday life. In the case of air travel, travelers go through a series of actions: reserving a seat on a passenger airplane, arriving at the airport before departure time to complete boarding procedures, boarding the airplane, taking off, flying, and landing to reach their destination. In addition, sharing the same time and space with many other travelers on a passenger airplane that departs at a predetermined time enhances the excitement of the travel.
Related Art List: (Patent Literature 1) JP 2020-087181 A

Currently, travel demand is rapidly declining due to the impact of a new type of coronavirus infection (COVID-19). The sharp decline in travel demand has dealt a severe blow not only to the airline industry but also to the management of airport retail outlets.

In addition, it is becoming more difficult to organize gatherings as well as travel.

### SUMMARY

This invention was completed based on the above background, and its main object is to provide a travel experience or a gathering experience through virtual reality technology.

A virtual travel system in one aspect of the present invention includes: a boarding request reception unit that accepts a boarding request for a vehicle from a communication terminal of a user prior to the departure time of the vehicle; a boarding processing unit that registers the user who has sent a boarding request for the vehicle as a passenger of the vehicle; and a boarding experience provision unit that provides a common boarding experience to a plurality of passengers of the vehicle.

A communication terminal in one aspect of the present invention includes: an input unit that accepts a boarding procedure on the condition that the boarding procedure is performed prior to the departure time of the virtual passenger airplane from the user; a transmission unit that transmits a boarding request together with a user ID to an external airline management server when the boarding procedure is accepted; a reception unit that receives an image of a virtual space representing the cabin of the virtual passenger airplane after receiving boarding permission for the virtual passenger airplane from the airline management server; and a display unit for displaying the image of the virtual space image on a screen.

The display unit displays an avatar, which is a character corresponding to another user who has completed a boarding procedure for the virtual passenger airplane, in the cabin of the virtual passenger airplane.

A virtual gathering system in one aspect of the present invention includes: a participation request reception unit that receives a participation request from a communication terminal of a user for a virtual gathering to be held in a virtual space based on a predetermined schedule; a registration processing unit that registers a user who has made a participation request for a virtual gathering as a participant of the virtual gathering; and a gathering experience provision unit that provides a common gathering experience to a plurality of participants of the virtual gathering.

The registration processing unit registers a user as a participant of the virtual gathering on the condition that the avatar that is a character corresponding to the user satisfies predetermined eligibility for participation in the virtual gathering.

A communication terminal in another aspect of the present invention includes: a gathering event details reception unit that receives event details of a gathering including a holding date and time of a gathering and a designated item; a wearing instruction input unit that accepts a wearing instruction for an avatar owned by a user to wear an adornment as a designated item; a participation instruction input unit that accepts a request for participation in the virtual gathering; a transmission unit that, when the participation request is accepted, transmits the participation request together with a user ID to an external gathering server; an image reception unit that, after receiving participation permission for the virtual gathering from the gathering server, receives an image of a virtual space representing the venue of the virtual gathering; and a display unit that displays an image of the virtual space on a screen.

The display unit displays an avatar wearing a designated item corresponding to another user in the venue of the virtual gathering.

The present invention can provide users with an experience similar to a real travel or gathering through virtual reality technology.

### BRIEF DESCRIPTION OF DRAWINGS

FIG. 1 is a schematic diagram illustrating an outline of a virtual travel;

FIG. 2 is a schematic diagram illustrating a travel itinerary from Haneda Airport to Clock Tower via New Chitose Airport;

FIG. 3 is a hardware configuration diagram illustrating a virtual airline service system;

FIG. 4 is a functional block diagram illustrating an airline management server and a user terminal;

FIG. 5 is a screen diagram illustrating an airplane search screen;

FIG. 6 is a screen diagram illustrating an airplane reservation screen;

FIG. 7 is a data structure diagram illustrating passenger information;

FIG. 8 is a screen diagram illustrating a boarding gate at Haneda Airport;

FIG. 9 is a screen diagram illustrating a cabin of a virtual passenger airplane;

FIG. 10 is a screen diagram illustrating the vicinity of a virtual store at New Chitose Airport;

FIG. 11 is a screen diagram illustrating the vicinity of Clock Tower;

FIG. 12 is a hardware configuration diagram illustrating a virtual gathering system;

FIG. 13 is a functional block diagram illustrating a gathering server and a user terminal;

FIG. 14 is a screen diagram illustrating a virtual gathering reservation screen;

FIG. 15 is a screen diagram illustrating an item purchase screen;

FIG. 16 is a screen diagram illustrating a gathering space;

FIG. 17 is a schematic diagram illustrating a talkable range between avatars; and

FIG. 18 is a schematic diagram illustrating how to hold a virtual gathering and a real gathering simultaneously.

### DETAILED DESCRIPTION

In the following, travel experiences and gathering experiences will be explained respectively. The first embodiment will be explained by focusing on virtual travel, and the second embodiment will be explained by focusing on virtual gathering. When the first and second embodiments are not specifically distinguished, or when they are referred to collectively, they will be simply referred to as “this embodiment.”

### First Embodiment

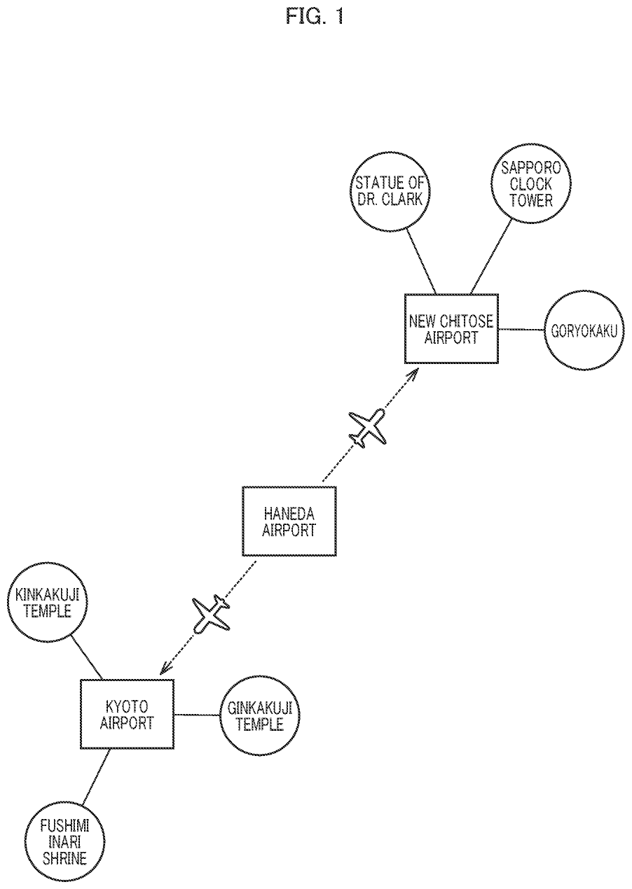

FIG. 1 is a schematic diagram illustrating an outline of a virtual travel.

The first embodiment provides users with a travel experience based on virtual reality technology (hereinafter referred to as “virtual travel”). Specifically, virtual spaces that imitate an airport, a passenger airplane, and tourist spots are generated by using three-dimensional computer graphics. In the following, unless otherwise specified, the virtual space imitating an airport will be referred to as an “airport space,” a “virtual airport,” or simply an “airport.” The same applies to passenger airplanes and tourist spots. When it is clearly indicated that the airport actually exists, it is referred to as a “real airport” as appropriate. The same applies to passenger airplanes and tourist spots.

As an example, Haneda Airport, New Chitose Airport, and Kyoto Airport are constructed as virtual spaces. For Haneda Airport and New Chitose Airport, the premises of the real airports are reproduced as a three-dimensional virtual space by using computer graphics. However, the airport retailers in the virtual airport need not be the same as those in the real airport. Kyoto Airport does not exist in the real world. Therefore, the designer can freely design an airport as Kyoto Airport.

The user can stroll around the premises of the virtual airport by moving a character that is his/her alter ego (hereinafter referred to as “avatar”) in the virtual space with the same feeling as in a game. In the following, the experience in the virtual airport through the user's avatar is referred to as the “airport experience.”

As described in detail below, the user accesses the airline management server from a communication terminal such as a smartphone, and the airline management server provides the user with an airport experience at Haneda Airport. The user boards a virtual passenger airplane by completing a boarding procedure through an avatar at the virtual Haneda Airport. During boarding, the “boarding experience” is provided in the virtual passenger airplane space.

After a 20-minute boarding experience (flight) on the virtual passenger airplane, the virtual passenger airplane lands at another virtual airport, such as the virtual New Chitose Airport. The airline management server then provides the user with the airport experience of the virtual New Chitose Airport. Users can also enjoy shopping at virtual stores opened in the virtual airport by controlling their avatars.

A virtual airport is associated with a number of virtual tourist spots in advance. The virtual New Chitose Airport is associated with the statue of Dr. Clark, Sapporo Clock Tower, Goryokaku, and other tourist spots that are famous in Hokkaido. The virtual Kyoto airport is associated with Kinkakuji Temple, Ginkakuji Temple, Fushimi Inari Shrine, and other tourist spots that are famous in Kyoto. Virtual spaces for these tourist spots are also constructed in advance. Users can enjoy strolling around the virtual Sapporo Clock Tower (hereinafter referred to as “virtual Clock Tower” or simply “Clock Tower”) by moving the avatar to the virtual Clock Tower. In the following, the experience at a tourist spot through the user's avatar will be referred to as the “tourist experience.”

For example, in order to enjoy a sightseeing tour of Clock Tower, the user needs to complete a boarding procedure from Haneda Airport and land at New Chitose Airport by airplane. In other words, the procedure of “going from Tokyo to Hokkaido” is a prerequisite for enjoying the Clock Tower tourist experience. By experiencing the travel process (flow) in turn in the virtual space, users can enjoy the feeling of traveling in the virtual space.

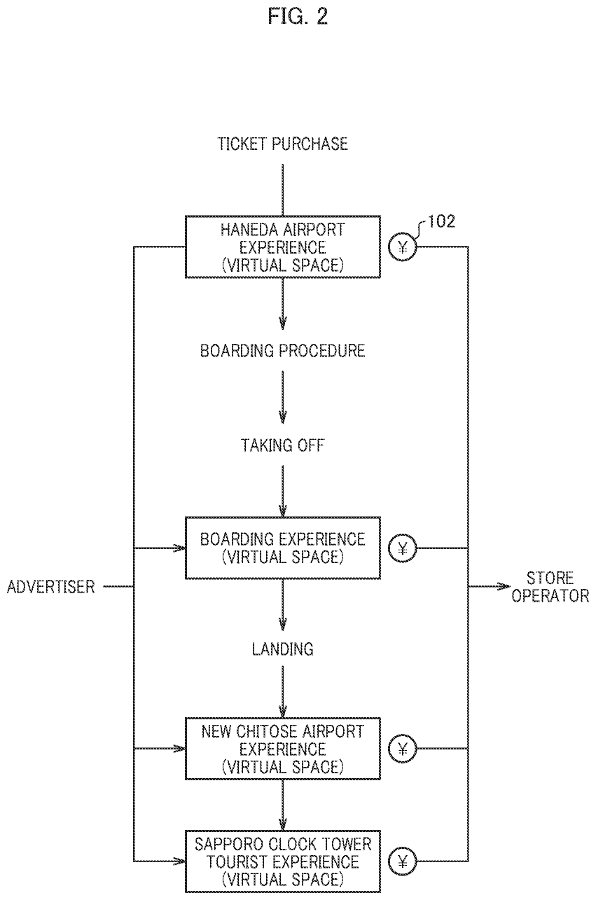

FIG. 2 is a schematic diagram illustrating a travel itinerary from Haneda Airport to Clock Tower via New Chitose Airport.

The user first selects a character to be his/her avatar from multiple types of characters. Each of the multiple users selects an avatar, and the multiple users interact through their avatars in a common virtual space. The avatar may be a character that is a faithful representation of a real person, a character that simplifies, omits, or emphasizes human characteristics, or a character that imitates a non-human or non-living creature such as a robot or animal.

The user accesses the airline management server, determines a departure date, and purchases a ticket (airline ticket) for the virtual passenger airplane. The virtual passenger airplane in the first embodiment, like a real passenger airplane, has a flight schedule (airport of departure (hereinafter referred to as “departure airport”), departure time, arrival time, airport of destination (hereinafter referred to as “arrival airport”)), and boarding capacity. Users need to complete a user registration process in advance. The airline management server registers information about the user in advance, such as user ID, name, address, credit card number, and bank account information. When a user purchases a ticket, the airline management server debits the ticket price from the bank account of the user.

When the departure time of the virtual passenger airplane approaches, the user who has obtained the ticket accesses the airline management server again and enters the virtual space of Haneda Airport, the departure airport. In the Haneda Airport space, the user can let his/her avatar stroll around by using operating devices such as a mouse, joystick, keyboard, and trackball. There are also virtual stores at Haneda Airport where users can purchase items for a fee. The purchase mark 102 in FIG. 2 indicates that there is an opportunity to purchase an item.

The user moves the avatar to the boarding gate in the Haneda Airport space and presents the ticket to complete the boarding procedure for the virtual passenger airplane. The avatar moves into the passenger airplane space and takes a seat. The virtual passenger airplane takes off at the predetermined departure time. At that time, an animated takeoff scene of the virtual passenger airplane is displayed on the user's communication terminal.

After boarding, the user enjoys a 20-minute flight through the avatar. In the passenger airplane space, the user can receive various services from a character acting as a flight attendant (hereinafter referred to as “flight attendant character”). The flight attendant character also sells in-flight merchandise. The user selects an item object to be purchased from the item objects brought by the flight attendant character. At that time, the airline management server settles the payment for the item and arranges for the delivery to the user's home of the item (real object) preliminarily associated with the selected item object (virtual object). For example, when a user purchases a “stuffed animal (virtual object)” from the flight attendant character, a “stuffed animal (real object)” of the same type will be delivered to his/her home at a later date.

As the scheduled arrival time approaches, the virtual passenger airplane enters the landing mode. At that time, an animated landing scene of the virtual passenger airplane is displayed on the user's communication terminal.

After the landing, the avatar enters the New Chitose Airport space. The New Chitose Airport space also includes many virtual stores. The virtual stores in the New Chitose Airport space offer a variety of Hokkaido-specific items from local vendors in Hokkaido. In other words, the virtual stores at New Chitose Airport sell “Hokkaido-specific” items that are not sold at virtual stores in other regions, such as Haneda Airport.

The avatar moves to the virtual Clock Tower, one of the tourist spots associated with New Chitose Airport. In the virtual Clock Tower, a virtual space similar to the real Sapporo Clock Tower is constructed, and users can enjoy sightseeing in the virtual space through their avatars. There are also many virtual stores around Clock Tower.

Store operators can purchase the right to display their items at virtual stores located at Haneda Airport, passenger airplanes, New Chitose Airport, or Clock Tower and sell them to users. When a user purchases an item, the payment for the item is transferred from the bank account of the user to the bank account of the store operator. When an item of a store operator is sold in the virtual space, the store operator actually ships the item to the user.

Advertisement spaces are provided in advance in the virtual space. The operator of the airline management service sells the advertisement spaces in the virtual space. A large number of avatars gather in a virtual space such as Haneda Airport. Users see many advertisements in the virtual space through their avatars. Advertisers can purchase the advertisement space and paste their own advertising images there.

Advertising fees generate revenue for the operation of the airline management service. For example, a small business that cannot advertise at the real New Chitose Airport may be able to advertise at a lower cost at the virtual New Chitose Airport. In this way, by selling advertisement spaces at a lower cost at virtual airports, tourist spots, or passenger airplanes, it becomes easier to provide advertising opportunities to a wide range of local industries that are not well known to the general public.

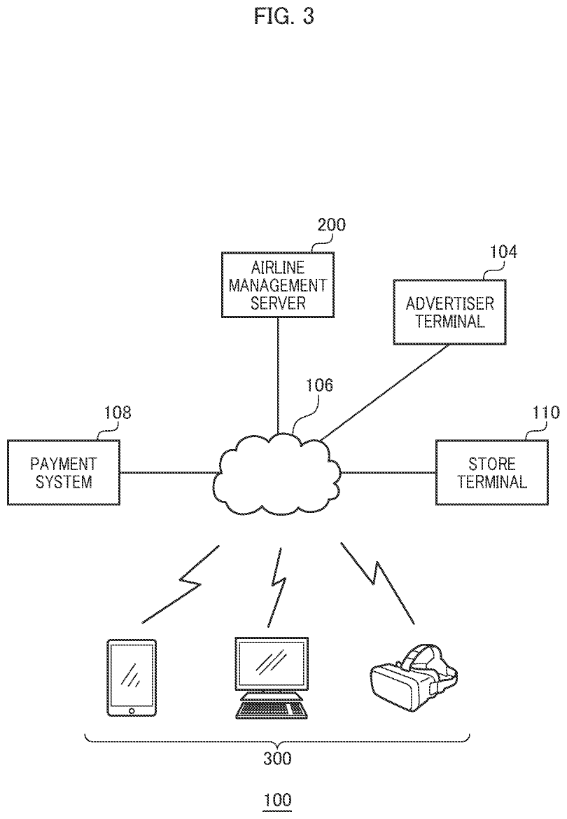

FIG. 3 is a hardware configuration diagram illustrating a virtual airline service system 100.

The virtual airline service system 100 includes an airline management server 200, a user terminal 300, a payment system 108, an advertiser terminal 104, and a store terminal 110. The airline management server 200, the user terminal 300, the payment system 108, the advertiser terminal 104, and the store terminal 110 are interconnected via the Internet 106. The user terminal 300 is a communication terminal used by a user of the virtual airline service and can be any computer with communication and display functions, such as a smartphone, a tablet computer, a desktop PC, a laptop PC, and VR (Virtual Reality) goggles, among other devices. The user terminal 300 may also be a dedicated device installed in an amusement arcade or other location.

The airline management server 200 provides various services related to virtual travel to the user terminal 300. As mentioned above, the user registers with the airline management server 200 in advance. At that time, the user registers his/her name, address, bank account information, and credit card number, among other information, with the airline management server 200, and the airline management server 200 assigns a user ID to each user.

The payment system 108 is a server operated by a financial institution. The airline management server 200 sends payment instructions to the payment system 108 when a user purchases a ticket for a virtual passenger airplane or makes a purchase on board or at a virtual store, and the payment system 108 settles the charges. The advertiser terminal 104 is a communication terminal used by the advertiser. The advertiser sends information from the advertiser terminal 104 to the airline management server 200 regarding the advertisement data (images), the location where the advertisement is to be placed, and the information about the advertiser, and the airline management server 200 places the advertisement image in the designated advertisement space in the virtual space.

The advertiser registers with the airline management server 200 as an advertiser user. The airline management server 200 sets the advertisement space information for each advertisement space, including the posting period, the posting fee, the payment method, and the eligibility for posting, and communicates this information to those who wish to post advertisements. For example, for an advertisement space at New Chitose Airport, it is possible to specify that only residents of Hokkaido are eligible to place an advertisement.

The airline management server 200 may request those who wish to post advertisements at New Chitose Airport (virtual airport) to provide information that proves that he/she is a resident of Hokkaido. For example, those who wish to post advertisements may send an image of an official document such as a driver's license with his/her address on it along with the advertisement posting request to the airline management server 200, which analyzes the image to determine whether or not the person who wishes to post advertisements is a resident of Hokkaido, or in other words, whether or not the person is eligible to place the advertisement.

The advertiser refers to the advertisement space information and notifies the airline management server 200 of the advertisement space in which he/she wishes to post advertisements. The airline management server 200 debits the bank account of the advertiser for the advertisement fee and places the advertisement in the virtual space by pasting the advertisement image data provided by the advertiser into the designated advertisement space.

The store terminal 110 is a communication terminal used by the store operator. From the store terminal 110, the store operator transmits information about a virtual store in which he/she wishes to display items, an item list, and the store operator. The airline management server 200 places item objects (virtual objects) corresponding to the item list in the designated virtual store. The store operator may buy the right to display items for a part of the space in the virtual store or may buy the entire virtual store.

The store operator may also sell items on board. Specifically, the store operator transmits information from the store terminal 110 to the airline management server 200, including the virtual passenger airplane on which it wishes to display its items, an item list designating the items to be displayed, and the store operator. In the designated virtual passenger airplane, the flight attendant character patrols the airplane, holding item objects (virtual objects) corresponding to the item list. Alternatively, the flight attendant character may hold an object showing the item menu corresponding to the item list.

In the virtual store, the user selects an item object and purchases the selected item. The airline management server 200 debits the item price from the bank account of the user and deposits the item price into the bank account of the store operator. At the same time, the airline management server 200 notifies the store operator of the user's address and the name of the purchased item, and the store operator delivers the real item to the user's address. In other words, the user enjoys shopping in the virtual space, and the real item is delivered to his/her home a few days later. The item delivery may be an anonymous delivery method in which the operator of the airline management server 200 acts as escrow and does not notify the store operator of the purchaser's personal information.

The same applies to in-flight sales. The user selects an item to purchase from the items presented by the flight attendant character in the virtual passenger airplane. Specifically, the user designates the desired item object among the multiple item objects held by the flight attendant character. Alternatively, the user may select a desired item from the item menu presented by the flight attendant character. In this case, as well, the airline management server 200 executes the payment for the item and instructs the store operator to deliver the real item to the user's address.

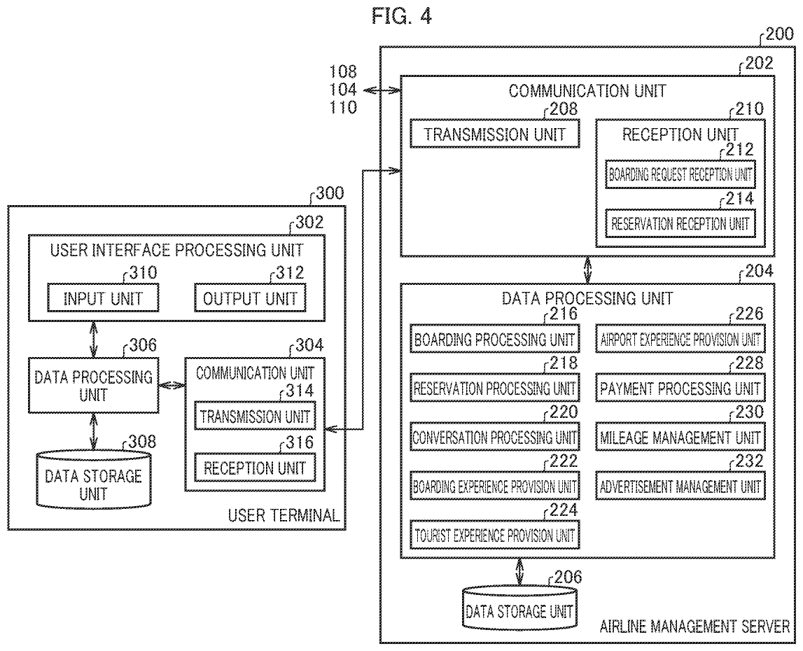

FIG. 4 is a functional block diagram illustrating the airline management server 200 and the user terminal 300.

The components of the airline management server 200 and the user terminal 300 are implemented by hardware including computing units such as central processing units (CPUs) and various co-processors, storage devices such as memories and storages, and wired or wireless communication lines that connect these units and devices, and software that is stored in the storage devices and supplies processing instructions to the computing units. Computer programs may be constituted by device drivers, operating systems, various application programs on upper layers thereof, and a library that provides common functions to these programs.

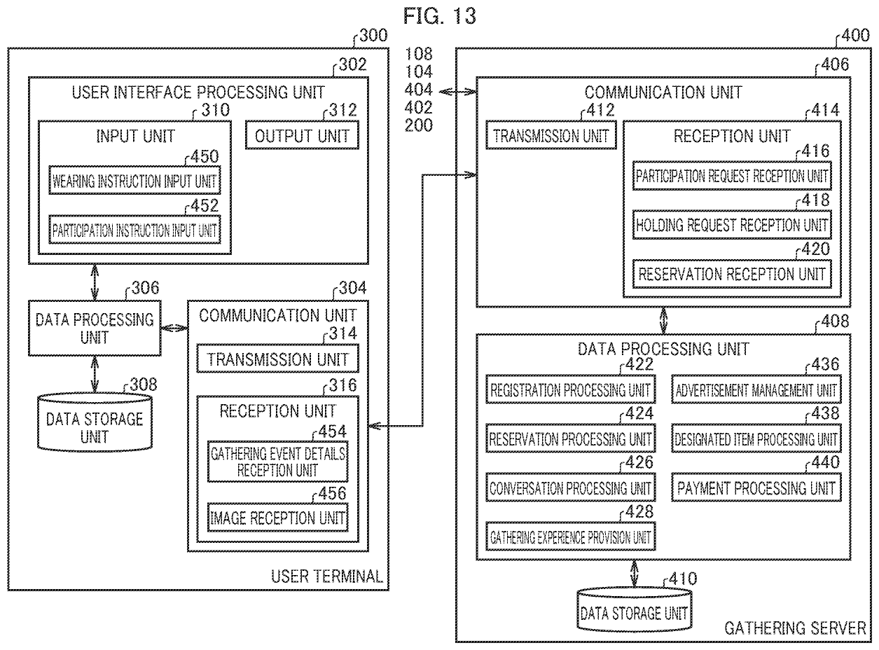

Each of the blocks described below does not represent a hardware block but represents a functional block. The same applies to the gathering server 400 and the user terminal 300 shown in FIG. 13.

Airline Management Server 200

The airline management server 200 includes a communication unit 202, a data processing unit 204, and a data storage unit 206.

The communication unit 202 is responsible for communication processing with the user terminal 300, the payment system 108, the advertiser terminal 104, and the store terminal 110. The data storage unit 206 stores various types of data, including image data of the virtual space, characters, information about users, information about advertisers, and information about store operators. The data processing unit 204 executes various processes based on data acquired by the communication unit 202 and data stored in the data storage unit 206. The data processing unit 204 also functions as an interface of the communication unit 202 and the data storage unit 206.

The communication unit 202 includes a transmission unit 208 that transmits various information to external devices such as the user terminal 300 and a reception unit 210 that receives various information from the external devices.

The reception unit 210 includes a boarding request reception unit 212 and a reservation reception unit 214.

The boarding request reception unit 212 receives a boarding request from the user terminal 300 to board the virtual passenger airplane. The reservation reception unit 214 receives a boarding reservation for the virtual passenger airplane from the user terminal 300.

The data processing unit 204 includes a boarding processing unit 216, a reservation processing unit 218, a conversation processing unit 220, a boarding experience provision unit 222, a tourist experience provision unit 224, an airport experience provision unit 226, a payment processing unit 228, a mileage management unit 230, and advertisement management unit 232.

The boarding processing unit 216 executes the processes related to a boarding procedure when the avatar comes to the boarding gate in the airport space. The avatar boards the virtual passenger airplane on the condition that the avatar has purchased a ticket for the virtual passenger airplane in advance and has completed the boarding procedure in the airport space.

The reservation processing unit 218 executes the reservation process for the virtual passenger airplane. When the virtual passenger airplane is reserved by a user, the reservation processing unit 218 issues a ticket (airline ticket) to the user. The conversation processing unit 220 processes conversations among users. In the first embodiment, users can communicate via text chat. The boarding experience provision unit 222 provides the user with a virtual airplane boarding experience. The tourist experience provision unit 224 provides the user with a tourist experience at a virtual tourist spot. The airport experience provision unit 226 provides the user with an airport experience of a virtual airport.

The payment processing unit 228 executes the payment processing by issuing instructions to the payment system 108. The payment processing unit 228 executes payment processing for the purchase of tickets for a virtual passenger airplane, the purchase of items in virtual stores or in-flight sales, as well as the collection of advertising fees when advertising is posted.

The mileage management unit 230 manages the mileage points for each user. When a user boards a virtual passenger airplane, the mileage management unit 230 awards mileage points to the user. The user can use the mileage points to get discounts when purchasing tickets or items. The advertisement management unit 232 manages the advertisement space in the virtual space. The advertisement management unit 232 manages advertisement space IDs, advertisers, advertisement images, posting periods, and posting fees in association, and deletes advertisement images when the posting period has expired. When a new advertisement is posted in an advertisement space, the advertisement management unit 232 instructs the payment processing unit 228 to collect the posting fee.

User Terminal 300

The user terminal 300 includes a user interface processing unit 302, a communication unit 304, a data processing unit 306, and a data storage unit 308.

The user interface processing unit 302 accepts operations from the user via input devices such as a keyboard, a mouse, a joystick, and a touch panel and is also responsible for processing related to the user interface, such as image display and audio output. The communication unit 304 is responsible for communication processing with the airline management server 200. The data storage unit 308 stores various data. The data processing unit 306 executes various processes based on inputs from the user interface processing unit 302, data received by the communication unit 304, and data stored in the data storage unit 308. The data processing unit 306 also functions as an interface of the communication unit 304, the user interface processing unit 302, and the data storage unit 308.

The user interface processing unit 302 includes an input unit 310 and an output unit 312.

The input unit 310 accepts various inputs from the user. The user controls the avatar in the virtual space via the input device through a user interface similar to that of a computer game. In the following, the avatar will be referred to as “the user's own avatar” when it needs to be clearly indicated that it corresponds to the user himself/herself and is the avatar to be controlled by the user, and as “the other avatar” when it needs to be clearly indicated that it is an avatar to be controlled by another user.

The output unit 312 outputs various information to the user. The output unit 312 displays various information on a monitor and outputs various sounds.

The communication unit 304 includes a transmission unit 314 for transmitting various data and a reception unit 316 for receiving data.

In the following, the user interface will be described in the same context as FIG. 2, focusing on the user interface as the avatar boards the virtual passenger airplane from Haneda Airport, arrives at New Chitose Airport, and goes sightseeing at Clock Tower.

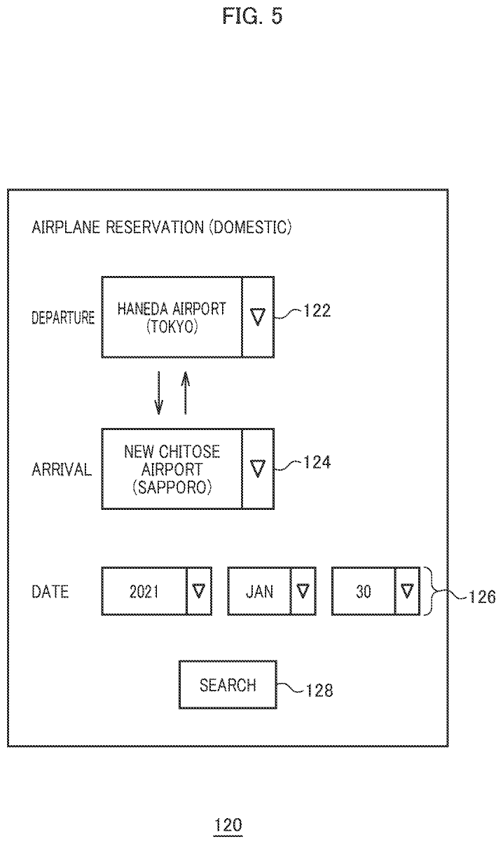

FIG. 5 is a screen diagram illustrating the airplane search screen 120.

In the first embodiment, multiple virtual passenger airplanes are in operation. The virtual passenger airplanes have a predefined flight schedule. A user who wishes to make a virtual travel accesses the airline management server 200 after completing user registration. At that time, the transmission unit 208 of the airline management server 200 transmits the airplane search screen 120 as a web page to the user terminal 300.

The flight schedules of virtual passenger airplanes are uniquely and strictly defined within the virtual space, independent of the flight schedules of real virtual passenger airplanes. For example, the schedule of a virtual passenger airplane A1 is set to fly between New Chitose Airport and Haneda Airport twice a week at a fixed date and time. Therefore, the user can board the virtual passenger airplane A1 only twice a week, and the user who wishes to board the virtual passenger airplane A1 needs to adjust his/her schedule according to the flight schedule of the virtual passenger airplane A1, just as he/she does when boarding a real passenger airplane.

The user selects the departure airport in the departure airport field 122 and the arrival airport in the arrival airport field 124. In FIG. 5, “Haneda Airport (Tokyo)” is selected as the departure airport and “New Chitose Airport (Sapporo)” is selected as the arrival airport.

The user then selects the desired departure date in the departure date field 126. In FIG. 5, a virtual passenger airplane departing on “Jan. 31, 2021” is designated. After setting the departure airport field 122, the arrival airport field 124, and the departure date field 126, the user touches the search button 128. At that time, the user terminal 300 sends a search request including the input information of the airplane search screen 120 to the airline management server 200.

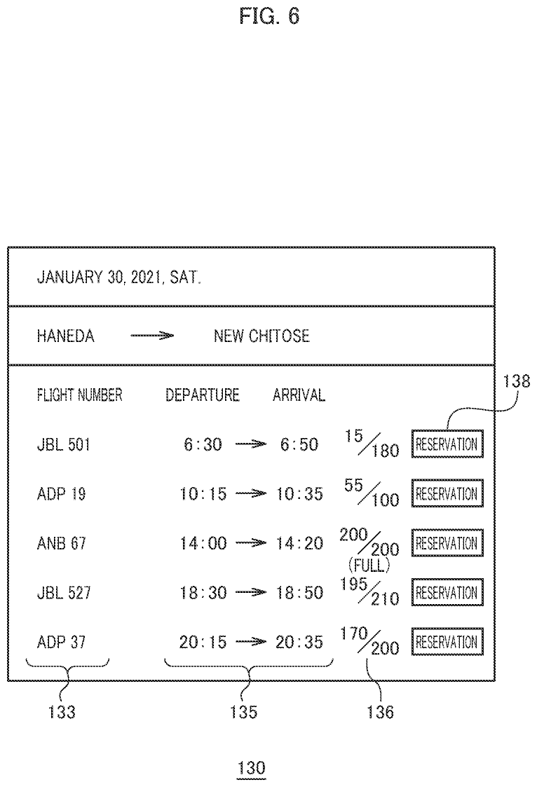

FIG. 6 is a screen diagram illustrating an airplane reservation screen 130.

Upon receiving the search request, the reservation processing unit 218 refers to the flight schedule of virtual passenger airplanes registered in the data storage unit 206 to generate the airplane reservation screen 130 showing a list of virtual passenger airplanes that meets the search criteria. According to the airplane reservation screen 130 shown in FIG. 6, there are five virtual passenger airplanes that meet the search criteria of “Departure airport: Haneda,” “Arrival airport: New Chitose,” and “Departure date: Jan. 31, 2021.”

The flight number field 133 indicates the flight number of the virtual passenger airplane. The flight numbers are set for a virtual passenger airplane in the same way as for real passenger airplanes. The flight number functions as the ID of the virtual passenger airplane. The exterior, the interior, the boarding capacity, and the type and number of flight attendant characters of the virtual passenger airplane also differ for each virtual passenger airplane.

The time field 135 indicates the departure time and scheduled arrival time. The number-of-passengers field 136 indicates the number of passengers/boarding capacity. For example, the virtual passenger airplane (JBL501) departs from the virtual Haneda Airport at 6:30 on January 31 and arrives at the virtual New Chitose Airport at 6:50. The capacity is 180 passengers, and 15 passengers are currently reserved, so up to 165 more passengers can be reserved. Users who have reserved a virtual passenger airplane (JBL501) need to enter the virtual Haneda Airport space and complete the boarding procedure described below by 6:30 on January 31.

The virtual passenger airplane (ANB67) with a boarding capacity of 200 is fully reserved. For this reason, reservations made now will be placed on a waiting list.

Since the virtual passenger airplane is not constrained by the physical boarding area, it can actually accommodate any number of passengers. However, since the boarding capacity is set in advance for the virtual passenger airplane in this system, no new boarding reservations will be accepted once the airplane is full. In addition, as described below, the avatar seat is also fixed. By imposing temporal and spatial constraints through the flight schedule and the boarding capacity, a virtual passenger airplane can provide users with a boarding experience similar to that of a real airplane.

When a user boards a virtual passenger airplane, he/she sees other avatars in the cabin space. If a large number of passengers have reservations for a virtual passenger airplane, a large number of the other avatars will be displayed in the cabin. In the case of a deserted virtual passenger airplane, a small number of the other avatars are displayed in the cabin. Some of the passengers may be Non-Player Characters (NPCs). The boarding experience provision unit 222 may prepare a plurality of avatars as NPCs in advance and set them as passengers of the virtual passenger airplane. By preparing NPCs, the boarding rate of the virtual passenger airplane can be set above a certain value.

The user touches the reservation button 138 corresponding to the virtual passenger airplane he/she wishes to board. Here, it is assumed that the user reserves the virtual passenger airplane (JBL527). The virtual passenger airplane (JBL527) is a virtual passenger airplane departing at 18:30 with a boarding capacity of 210 (15 empty seats remaining). When the reservation button 138 is touched, the input unit 310 of the user terminal 300 sends a reservation request including the user ID and the flight number to the airline management server 200. The reservation reception unit 214 receives the reservation request. The reservation processing unit 218 registers the user as a “passenger” of the virtual passenger airplane (JBL 527) on the condition that there is an available seat on the virtual passenger airplane (JBL 527).

The virtual passenger airplane (JBL527) can accommodate up to 210 users. Users can also board the same virtual passenger airplane with their friends and family members. Because it is a virtual passenger airplane, passengers do not need to meet at Haneda Airport physically. For example, a family member in Osaka Prefecture and grandparents in Fukuoka Prefecture can board the same virtual passenger airplane via their respective user terminals 300.

In the first embodiment, payment is made at the time of reservation of the virtual passenger airplane. Specifically, the reservation processing unit 218 sends ticket information to the user terminal 300 and instructs the payment system 108 to debit the boarding fee from the bank account of the user registered in advance. The payment system 108 executes the debit from the bank account of the user and transfers the boarding fee to the bank account of the operator of the virtual airline service system 100. This completes the reservation process.

After the reservation is completed, the reservation processing unit 218 increments the number of passengers shown in the number-of-passengers field 136. The user can check the gradual decrease in the number of seats remaining on the virtual passenger airplane by viewing the airplane reservation screen 130. The user can also cancel the boarding reservation. In this case, the reservation processing unit 218 decrements the number of passengers shown in the number-of-passengers field 136. When the reservation is canceled, the reservation processing unit 218 instructs the payment system 108 to refund all or part of the collected boarding fee.

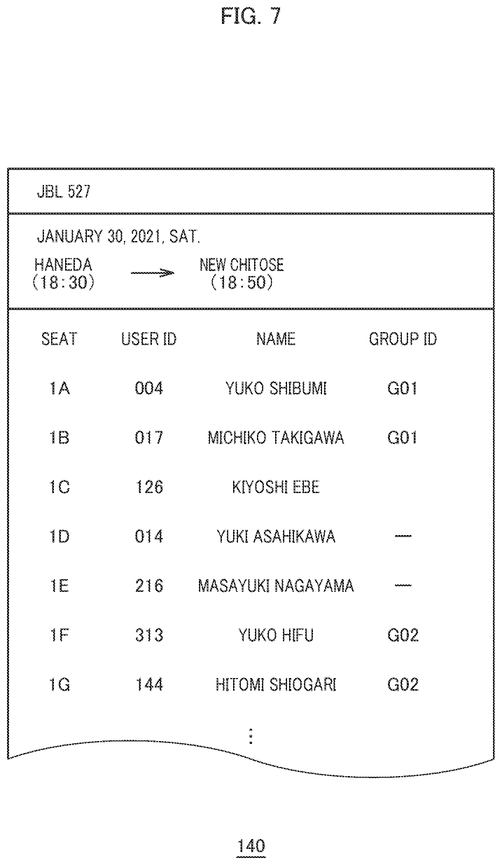

FIG. 7 is a data structure diagram illustrating passenger information 140.

The passenger information 140 is stored in the data storage unit 206 of the airline management server 200. The passenger information 140 is a passenger list for each virtual passenger airplane. The reservation processing unit 218 updates the passenger information 140 each time a reservation is accepted. The passenger information 140 shown in FIG. 7 shows the passenger list for the virtual passenger airplane (JBL527). Seat numbers are set for the seats of the virtual passenger airplane.

Multiple users may be registered together as a “group” at the time of reservation. The reservation processing unit 218 assigns a group ID to the group. The reservation processing unit 218 may adjust the boarding seats so that members of the same group, such as family members, are seated closer together. Alternatively, the user may select a boarding seat from a table of available seats at the time of reservation, in the same manner as when making a reservation for a real passenger airplane.

In the passenger information 140 shown in FIG. 7, “Yuko Shibumi (user ID: 004)” seated in seat (1A) and “Michiko Takigawa (user ID: 017)” seated in seat (1B) are in the same group. On the other hand, “Kiyoshi Ebe (user ID: 126)” seated in seat (1C) is a single traveler.

In the virtual passenger airplane, the user terminal of the user displays the cabin space as seen from the user's own avatar. Therefore, the view of the cabin space differs depending on the seat position of the user's own avatar. The seats may be classified as first class, business class, or economy class. In this case, the view of the cabin space differs depending on the class of the seat.

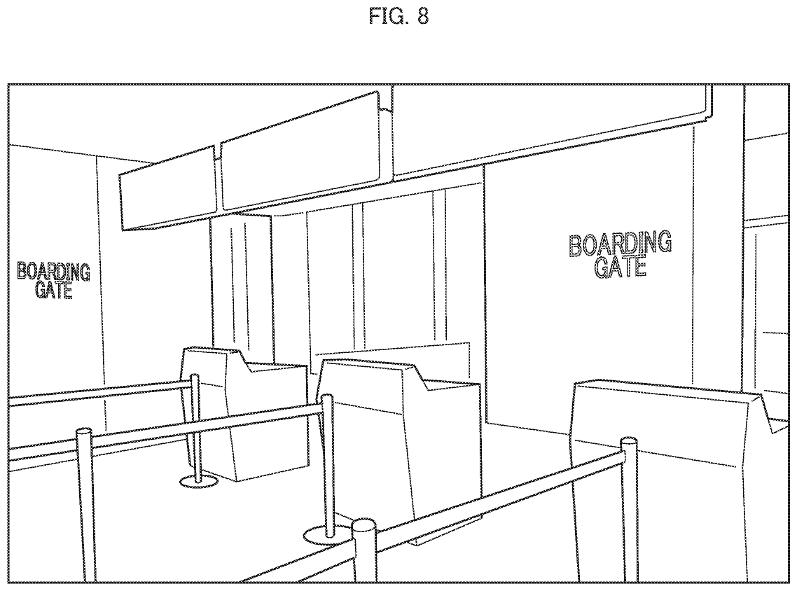

FIG. 8 is a screen diagram illustrating a boarding gate at Haneda Airport.

A user who has reserved the virtual passenger airplane (JBL527) logs into the airline management server 200 prior to the departure time (18:30 on Jan. 31, 2021). The airport experience provision unit 226 transmits a three-dimensional image of the Haneda Airport space to the user terminal 300. The user controls the user's own avatar to move through the Haneda Airport space. Since the reservation has been made, the user's own avatar has a ticket. Many other avatars also exist in the Haneda Airport space. The user can talk with the other avatars via text chat.

The user moves the avatar to the boarding gate in the Haneda Airport space. When the avatar arrives at the boarding gate, the user terminal 300 sends a boarding request including ticket information to the airline management server 200. The boarding request reception unit 212 receives the boarding request, and the boarding processing unit 216 executes the boarding process. Specifically, the boarding processing unit 216 checks the user's ticket information (flight number, departure time, and the like) and the passenger information 140 and guides the avatar to the virtual passenger airplane (JBL 527). The avatar moves to the virtual space representing the cabin of the virtual passenger airplane (JBL 527).

If the boarding procedure is not completed by 18:30, the departure time of the virtual passenger airplane (JBL527), boarding will be canceled. At that time, the boarding processing unit 216 instructs the payment system 108 to refund all or part of the airfare to the user. Thus, the user needs to go through the boarding procedure at the boarding gate of the virtual Haneda Airport in the same manner as the real boarding procedure so as not to be late for the departure time of the virtual passenger airplane.

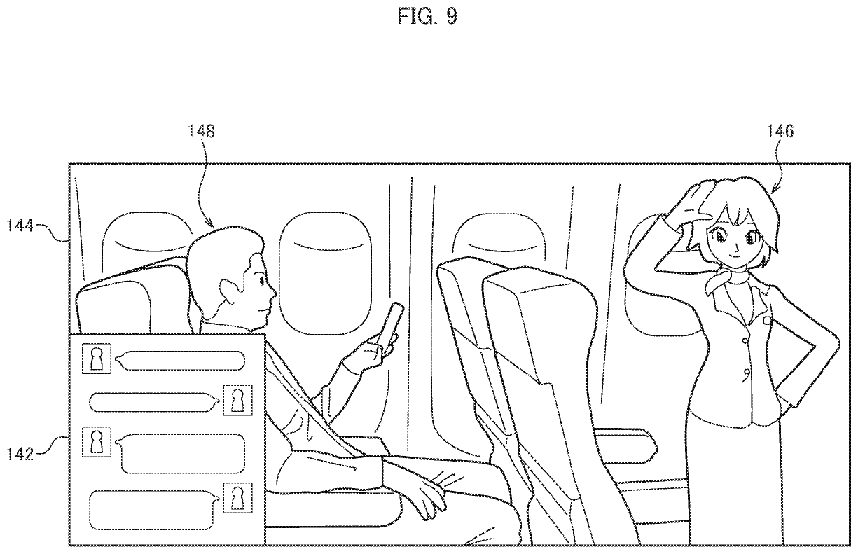

FIG. 9 is a screen diagram illustrating a cabin of a virtual passenger airplane.

After boarding the virtual passenger airplane (JBL527), the boarding experience provision unit 222 provides the boarding experience to the user. The boarding experience provision unit 222 transmits a three-dimensional image of the cabin space of the virtual passenger airplane. The user controls the user's own avatar to move to his/her seat and take a seat. When the departure time arrives, the virtual passenger airplane automatically takes off and departs for the arrival airport, New Chitose Airport. Twenty minutes after takeoff, the virtual passenger airplane lands at New Chitose Airport. The boarding experience provision unit 222 provides various boarding experiences to the user during these 20 minutes.

In the virtual passenger airplane, the other avatars 148 of other passengers are also displayed. In the case of the virtual passenger airplane (JBL527), approximately 200 users will share the boarding experience during the same time period in the same cabin space.

As mentioned above, the user terminal 300 displays a three-dimensional image of the cabin space based on the field of view of the user's own avatar. When there are approximately 200 passengers, many other avatars appear in this three-dimensional image so that the user can perceive a “crowded atmosphere” in the cabin space.

The boarding experience provision unit 222 overlays the cabin space screen 144, which is a three-dimensional image of the cabin, and the conversation screen 142. The user can have a text conversation with the other avatar on the conversation screen 142. For example, the user may talk with other users belonging to the same group. The conversation processing unit 220 relays the conversation by forwarding the text message input from the user to the conversation screen 142 of other users belonging to the same group.

The user may also talk with other users by voice through input/output devices such as a microphone and earphones. Specifically, assume that User P1 (passenger) speaks at the microphone. In this case, the conversation processing unit 220 outputs the voice input from the microphone on the user terminal 300 of another User P2 (passenger). This control method enables voice conversation between users who are boarding the same virtual passenger airplane.

The user can also talk with other users (the other avatars) who do not belong to the same group. For example, when the distance between the user's own avatar and the other avatar is within a predetermined range, the conversation processing unit 220 may control the conversation between the two when the avatar calls out to the other avatar and the other avatar responds.

More specifically, the conversation processing unit 220 calculates the linear distance in the virtual space between avatar Q1 of User P1 and avatar Q2 of User P2. When User P1 (avatar Q1) speaks in text or voice, the conversation processing unit 220 causes speech information of User P1 (avatar Q1) to be output from the user terminal 300 of User P2 (avatar Q2) when the linear distance between avatar Q1 and avatar Q2 is within a predetermined threshold value TX. In this way, the conversation processing unit 220 transmits the speech of User P1 to all avatars within threshold TX from avatar Q1. On the contrary, the speech information of User P1 is not communicated to avatars (users) located further away from avatar Q1 than threshold TX. By determining whether a conversation can be transmitted or not according to the distance between avatars, the conversation processing unit 220 can reproduce a situation similar to that in real space, where “a user can have a conversation with the other users only when the other users are nearby” in a virtual space.

In the case of voice conversation, the conversation processing unit 220 may change the threshold value TX according to the loudness of the speaker's voice. For example, when User P1 (avatar Q1) speaks in a low voice, the conversation processing unit 220 only transmits the voice to the user terminals 300 of the users within the threshold value TX1 from avatar Q1. On the contrary, when User P1 (avatar Q2) speaks in a loud voice, the conversation processing unit 220 may also transmit the voice to the users corresponding to the avatars within threshold TX2, which is farther from avatar Q1 than threshold TX1. According to such a control method, a user can transmit his/her voice to many users by speaking loudly, but a loud voice can also be annoying because it means that the voice reaches many users.

In the cabin space screen 144, one or more flight attendant characters 146 are also displayed. The boarding experience provision unit 222 causes the flight attendant character 146 to patrol in the cabin space screen 144. The flight attendant character 146 can also function as a chatbot, and a user can enjoy conversations with the flight attendant character 146. When the distance between the flight attendant character 146 and the user's own avatar is within a predetermined range, the user can talk with the flight attendant character 146. Since the flight attendant character 146 is also a kind of avatar, the method of conversation between the flight attendant character 146 and the user's own avatar is basically the same as that between the user's own avatar and the other avatar.

The user can ask the flight attendant character 146 to take a “commemorative photo.” If the flight attendant character 146 accepts the offer, the boarding experience provision unit 222 generates commemorative photo data depicting the user's own avatar and the flight attendant character 146 and sends it to the user terminal 300. For the commemorative photo, multiple avatars and the flight attendant character 146 can be photographed at the same time.

More specifically, when the user's own avatar and the flight attendant character 146 are within a predetermined distance, the user speaks to ask for a commemorative photo, such as “Please take a commemorative photo.” The boarding experience provision unit 222 determines whether or not to accept the commemorative photo offer. The boarding experience provision unit 222 may randomly decide whether or not to allow the commemorative photo, or it may decide to allow the commemorative photo unless the airplane is taking off or landing, or it may always decide to allow the commemorative photo. When accepting the offer, the flight attendant character 146 communicates a message to the user indicating that the commemorative photo offer is accepted, such as “OK.”

The boarding experience provision unit 222 then generates an image including the user's own avatar and the flight attendant character 146 with the cabin space in the background. The boarding experience provision unit 222 transmits this image, i.e., the image showing the commemorative photo of the two persons, to the user terminal 300 of the user.

The data storage unit 206 of the airline management server 200 stores the data of multiple types of flight attendant characters 146 in advance. The boarding experience provision unit 222 schedules when to have each flight attendant character 146 attend to which of the multiple virtual passenger airplanes. Thus, the user does not know which flight attendant character 146 he/she will encounter until boarding the virtual passenger airplane. When boarding the virtual passenger airplane, the user is provided with the pleasure of encountering a variety of flight attendant characters 146. In other words, the user is provided with the enjoyment of collecting commemorative photographs with a large number of flight attendant characters 146 by boarding a large number of virtual passenger airplanes. The commemorative photo function can motivate the user to board various virtual passenger airplanes.

The flight attendant character 146 may provide information about tourist spots around the arrival airport. The guidance may be in the form of text messages or voice announcements. The advertiser may also purchase the right to have the flight attendant character 146 present their items as a form of advertising. The flight attendant character 146 sells items on board.

Specifically, the flight attendant character 146 carries item objects that imitates items included in an item list predetermined by the store operator. The flight attendant character 146 may also carry a cart or basket loaded with the item objects. When the user's own avatar and the flight attendant character 146 are within a predetermined distance, the user speaks to ask for the purchase of an item, such as “I'll take the plastic model of the airplane.” Alternatively, the user may refer to the item objects held by the flight attendant character 146 and select the item object he/she wishes to purchase. The boarding experience provision unit 222 sends order information including the purchaser's user ID, address, and item ID to the store terminal 110 of the store operator providing the selected item. The store operator arranges delivery of the designated item to the user's address according to the order information. In addition, the boarding experience provision unit 222 instructs the payment system 108 to settle the payment for the item. The procedures for purchasing items in in-flight sales and in the virtual store described below are basically the same.

The boarding experience provision unit 222 provides various surprise events as part of the boarding experience. For example, the flight attendant character 146 may host a bingo game. Prizes may be provided for the bingo game. The payment processing unit 228 instructs the operator to arrange to deliver the prizes to the prize winner's home at a later date. The prize may be in the form of mileage points (frequent flyer points).

More specifically, during boarding, the boarding experience provision unit 222 causes the flight attendant character 146 to utter the words, “Would you like to play a bingo game?” The conversation processing unit 220 causes this speech information to be output from the user terminals 300 of all users. The user inputs whether or not to participate in the bingo game. The boarding experience provision unit 222 collects information from each user indicating whether they will participate or not and determines the participants. The boarding experience provision unit 222 then randomly distributes bingo game sheets to the participants. Several types of bingo game sheets are prepared in advance, and 24 of the numbers from “1” to “99” are arranged on each sheet. Each sheet is identified by a sheet ID.

The boarding experience provision unit 222 keeps track of which sheets have been distributed to which users. As a result, the participant's user ID is associated with the sheet ID. The user terminal 300 of the participant displays the sheet distributed to him/her on the screen. Next, the boarding experience provision unit 222 sets the order of speaking to the participants. The participant whose turn to speak arrives utters a freely selected number. For example, when User P1 utters “1”, the boarding experience provision unit 222 instructs each user terminal 300 to disable the number corresponding to “1” on the sheet. The user who first aligns the disabled number in his/her sheet vertically, horizontally, or diagonally in a row is the “winner.” The payment processing unit 228 arranges to deliver the prizes associated with the bingo game to the winner's registered address.

Passengers can play a tournament game of rock-paper-scissors among themselves. Alternatively, passengers and the flight attendant character 146 may play rock-paper-scissors. The flight attendant character 146 may quiz the passengers. In this way, the virtual passenger airplane in the first embodiment can perform various events that are not possible in a real passenger airplane. Through such events, interaction among passengers can be encouraged.

Specifically, the boarding experience provision unit 222 selects two people each from multiple passengers and sets them as opponents. Three types of hand sign images of rock, scissors, and paper are displayed on the user terminal 300, and the user selects one of them. The boarding experience provision unit 222 determines the winner based on the hand sign selected by the two opposing users. After the first round is completed, the boarding experience provision unit 222 selects two winners from each of the winners to decide the second round match. After repeating these rock-paper-scissors games, the user who finally wins becomes the “winner.” In this case, as well, the payment processing unit 228 arranges to deliver a predetermined prize to the registered address of the winner of the rock-paper-scissors tournament.

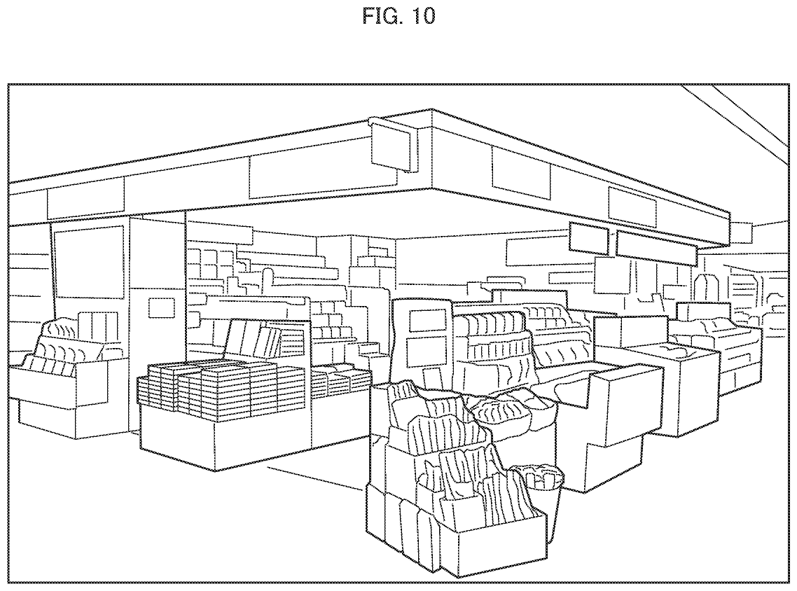

FIG. 10 is a screen diagram illustrating the vicinity of a virtual store at New Chitose Airport.

After the virtual passenger airplane (JBL527) lands at New Chitose Airport, the airport experience provision unit 226 provides an airport experience to the user. The airport experience provision unit 226 sends a three-dimensional image of the virtual space inside New Chitose Airport to the user terminal 300. The user controls the avatar to stroll around the New Chitose Airport space. A number of virtual stores are set up in the New Chitose Airport space. In addition, advertising images are displayed on the walls and the like.

The user moves the avatar and enters the virtual store of interest. In the virtual stores, there are many item objects. The item objects are three-dimensional virtual objects that have the same shape as the real item and are decorated with design images similar to those of the real item. Each item object is associated with item description information in advance. The item description information includes the product name, the manufacturer, the contents, the quantity, the price, and any other information about the item. When an avatar selects an item object, the transmission unit 208 of the airline management server 200 sends the item description information to the user terminal 300. The user terminal 300 displays the item description information on the screen, and the user refers to the item description information to determine whether to purchase it.

The user brings the item object he/she wishes to purchase to the payment counter in the virtual store. Once the avatar moves to the payment counter, the payment processing unit 228 executes the purchase and shipping of the item. The payment processing unit 228 first identifies the user ID, the item ID associated with the item object, and the store operator associated with the item ID. Next, the payment processing unit 228 instructs the payment system 108 to transfer the item price from the bank account of the user (purchaser) to the bank account of the store operator. After the transfer is completed, the payment system 108 sends a payment completion notification to the airline management server 200.

Upon receiving the payment completion notification, the payment processing unit 228 sends a shipping instruction for the item to the store terminal 110. The shipping instructions include the address of the user (purchaser) and the item ID. Upon receiving the shipping instruction at the store terminal 110, the store operator picks up the relevant item from its own warehouse and packs and ships the item to the user's address.

In this way, when a user selects an item object in the virtual store in the New Chitose Airport space and brings it to the payment counter, or in other words, indicates an intention to purchase, the airline management server 200 settles the payment for the item, and the user can have the real item corresponding to the item object delivered.

In addition, an item object can be discounted by using mileage points. In this case, the mileage management unit 230 discounts the price of the item based on the mileage points held by the user, and the operator of the virtual airline service system 100 compensates for the discount.

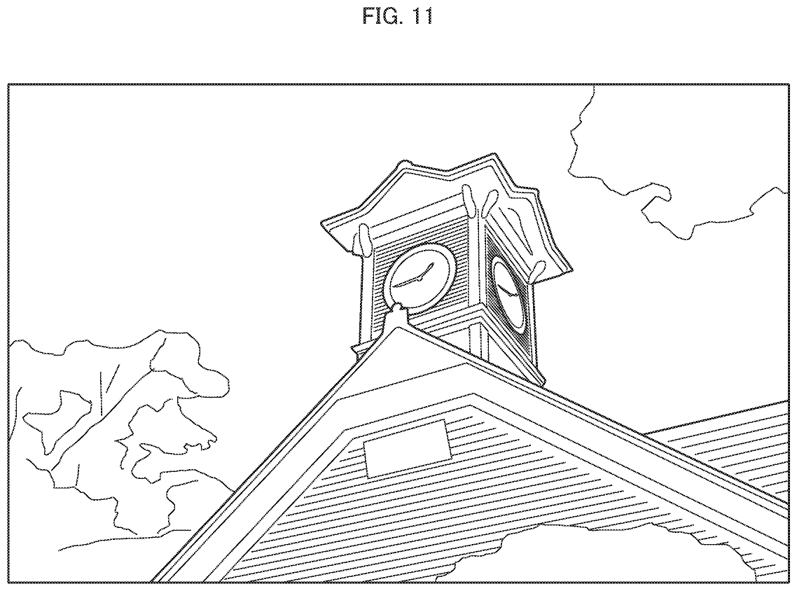

FIG. 11 is a screen diagram illustrating the vicinity of Clock Tower.

The user can select a destination from the tourist spots associated with New Chitose Airport. In this example, it is assumed that a user selects Clock Tower. The tourist experience provision unit 224 provides the user with a Clock Tower tourist experience. Specifically, the tourist experience provision unit 224 sends a three-dimensional image of a virtual space reproducing the area around Clock Tower to the user terminal 300. The user controls the avatar and strolls around Clock Tower. A number of virtual stores are located in the vicinity of Clock Tower. Advertising images are also displayed on the walls around Clock Tower.

At tourist spots, users can take commemorative photos. For example, a family of four (four avatars) can tour Clock Tower and take a commemorative photo with Clock Tower in the background. In the commemorative photo, the four avatars, which are the alter egos of the four people, and Clock Tower (virtual image) are reflected in the photo. In this way, even in a virtual space, users can enjoy the same kind of tourist experience as when they visit the real Clock Tower by providing a commemorative photo that can only be obtained by all four people who visit the virtual Clock Tower together.

The virtual stores around Clock Tower also display a variety of item objects by store operators specific to Hokkaido. By providing limited-edition items (item objects) that can only be purchased at the virtual stores around the virtual Clock Tower, the tourist experience can be made more enjoyable.

### Second Embodiment

The second embodiment provides users with a gathering experience (hereinafter referred to as a “virtual gathering”) that applies virtual reality technology. Specifically, a virtual space that imitates a conference room, a concert hall, or an outdoor gathering place is generated by using three-dimensional computer graphics. In the following, unless otherwise specified, the virtual space that imitates a gathering place will be referred to as a “gathering space.”

In the second embodiment, users can also stroll around the gathering space by moving their avatars in the virtual space with the same feeling as in a game. In the following, the experience of a virtual gathering through the user's avatar is referred to as the “gathering experience.”

The user accesses a gathering server and makes a reservation to participate in a virtual gathering. The virtual gathering has a predetermined schedule, just like a real gathering. As in the first embodiment, users need to complete a user registration process in advance. The gathering server registers information about the user in advance, such as user ID, name, address, credit card number, and bank account information. When a user purchases an item object that will serve as an avatar adornment (see below), the gathering server debits the purchase price from the bank account of the user.

Advertisement spaces are provided in advance in the gathering space. The operator of the gathering service sells the advertisement spaces in the gathering space. Advertisers can purchase the advertisement space and paste their own advertising images here.

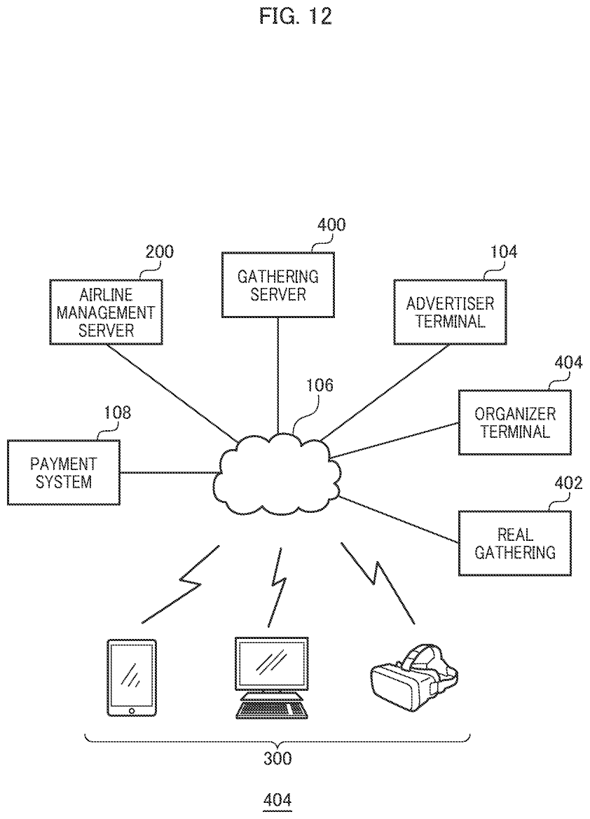

FIG. 12 is a hardware configuration diagram illustrating a virtual gathering system 404.

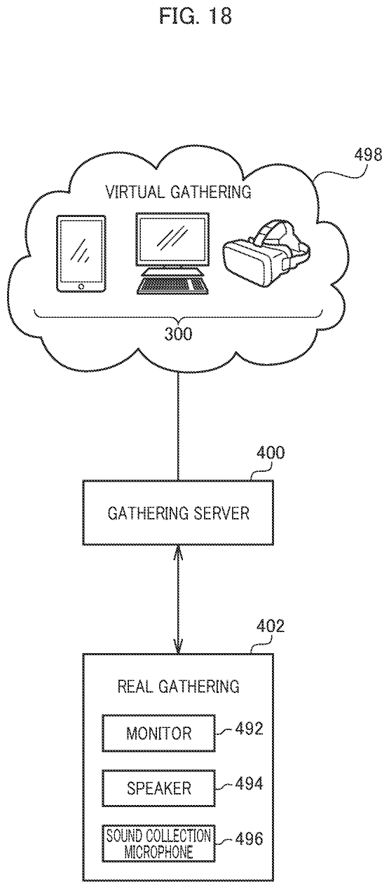

The virtual gathering system 404 includes a gathering server 400, an airline management server 200, a user terminal 300, a payment system 108, an advertiser terminal 104, an organizer terminal 404, and a real gathering 402. The real gathering 402 is a normal gathering held in a real space, not a virtual space. In the second embodiment, the virtual gathering and the real gathering can be held parallelly and simultaneously, the details of which are described below in connection with FIG. 18.

The gathering server 400, the airline management server 200, the user terminal 300, the payment system 108, the advertiser terminal 104, the organizer terminal 404, and the real gathering 402 are interconnected via the Internet 106.

The gathering server 400 provides various services related to the virtual gathering to the user terminal 300. As described above, a user registers with the gathering server 400 in advance. The gathering server 400 assigns a user ID to each user. The airline management server 200 and the gathering server 400 may be a single device. The airline management server 200 and the gathering server 400 may manage user information for a virtual travel service and user information for a virtual gathering service in a unified manner.

The organizer of a virtual gathering registers the event details of the virtual gathering from the organizer terminal 404 to the gathering server 400. The organizer also registers the user information to the gathering server 400 in advance. At that time, the organizer also registers his/her name, address, and bank account information, among other information, with the gathering server 400.

When a user purchases an item object in the virtual space, the gathering server 400 sends a payment instruction to the payment system 108, which settles the payment. The advertiser sends information from the advertiser terminal 104 to the gathering server 400 regarding the advertisement data (images), the location where the advertiser wants to advertise, and the advertiser, and the gathering server 400 pastes the advertisement image to the designated advertisement space in the virtual space.

The person submitting the advertisement also registers as a user with the gathering server 400. The gathering server 400 sets the advertisement space information for each advertisement space, including the posting period, the posting fee, the payment method, and the eligibility for posting and communicates this information to those who wish to post advertisements.

FIG. 13 is a functional block diagram illustrating the gathering server 400 and the user terminal 300.

Gathering Server 400

The gathering server 400 includes a communication unit 406, a data processing unit 408, and a data storage unit 410.

The communication unit 406 is responsible for communication processing with the airline management server 200, the user terminal 300, the payment system 108, the advertiser terminal 104, the organizer terminal 404, and various devices located at the real gathering 402. The data storage unit 410 stores various data, including image data of the virtual space, characters, item objects, information about users, information about advertisers, information about organizers, and schedules of virtual gatherings. The data processing unit 408 executes various processes based on data acquired by the communication unit 406 and data stored in the data storage unit 410. The data processing unit 408 also functions as an interface of the communication unit 406 and the data storage unit 410.

The communication unit 406 includes a transmission unit 412 that transmits various information to external devices such as the user terminal 300 and a reception unit 414 that receives various information from the external devices.

The reception unit 414 includes a participation request reception unit 416, a holding request reception unit 418, and a reservation reception unit 420.

The reservation reception unit 420 accepts a reservation for participation in a virtual gathering from the user terminal 300 (user). The participation request reception unit 416 receives a participation request for a virtual gathering from a reserved user. The participation request includes a user ID and avatar information. This avatar information includes the avatar ID, gender of the avatar, adornments worn by the avatar, activity history of the avatar, and information about the avatar's personal belongings. The holding request reception unit 418 receives a request to hold a virtual gathering from the organizer terminal 404 (organizer). The holding request includes event details.

The data processing unit 408 includes a registration processing unit 422, a reservation processing unit 424, a conversation processing unit 426, a gathering experience provision unit 428, an advertisement management unit 436, a designated item processing unit 438, and a payment processing unit 440.

Upon receiving a request to participate in a virtual gathering from a reserved user, the registration processing unit 422 determines whether the avatar (user) can participate in the virtual gathering to register the avatar (user) as a participant of the virtual gathering. The method of determining whether or not a user is allowed to participate is described below. The user who is allowed to participate can have his/her avatar enter the gathering space of the virtual gathering.

The reservation processing unit 424 executes the reservation process for the virtual gathering. When a reservation is made for participation in a virtual gathering, the reservation processing unit 424 issues a reservation ticket to the user. Only the user having the reservation ticket can participate in the virtual gathering. The conversation processing unit 426 processes conversations among users. In the second embodiment, users can communicate via text chat or voice. The gathering experience provision unit 428 provides a gathering experience to users.

The payment processing unit 440 executes the payment processing by issuing instructions to the payment system 108. The payment processing unit 440 executes the payment processing for the purchase of items by users as well as the collection of advertising fees when advertising is posted.

The advertisement management unit 436 manages the advertisement space in the virtual space. The advertisement management unit 436 manages advertisement space IDs, advertisers, advertisement images, posting periods, and posting fees in association, and deletes advertisement images when the posting period has expired. When a new advertisement is posted in an advertisement space, the advertisement management unit 436 instructs the payment processing unit 440 to collect the posting fee.

The designated item processing unit 438 presents item objects that can be worn or held by the avatar in the virtual space to the user. When the user selects an item object, the item object is provided to the user. For example, when User P1 purchases item object M1, the designated item processing unit 438 registers the user ID, the avatar ID, and item object M1 of User P1 in association with each other in the data storage unit 410. When the item object is not free, the designated item processing unit 438 instructs the payment processing unit 440 to collect the payment for the item from the bank account of the user.

In the following, the avatar of User P1 is denoted as “Avatar (P1).”

User Terminal 300

The user terminal 300 in the second embodiment also includes a user interface processing unit 302, a communication unit 304, a data processing unit 306, and a data storage unit 308.

The user interface processing unit 302 includes an input unit 310 and an output unit 312. The input unit 310 includes a wearing instruction input unit 450 and a participation instruction input unit 452. The wearing instruction input unit 450 accepts the user's selection of adornments (item objects) to be worn on or off the avatar. For example, when User P1 selects suit M2 (item object), the data processing unit 306 generates an image of Avatar (P1) wearing suit M2. The gathering experience provision unit 428 generates a gathering space based on the data of the avatars generated in this way. The participation instruction input unit 452 accepts participation requests for the virtual gathering from the user. In addition to this, the input unit 310 also accepts reservations to the virtual gathering from the user.

The communication unit 304 includes a transmission unit 314 for transmitting various data and a reception unit 316 for receiving data. The reception unit 316 includes a gathering event details reception unit 454 and an image reception unit 456. The gathering event details reception unit 454 receives the event details of the virtual gathering. The event details define the schedule of the virtual gathering. The image reception unit 456 obtains virtual images of the gathering space from the gathering experience provision unit 428.

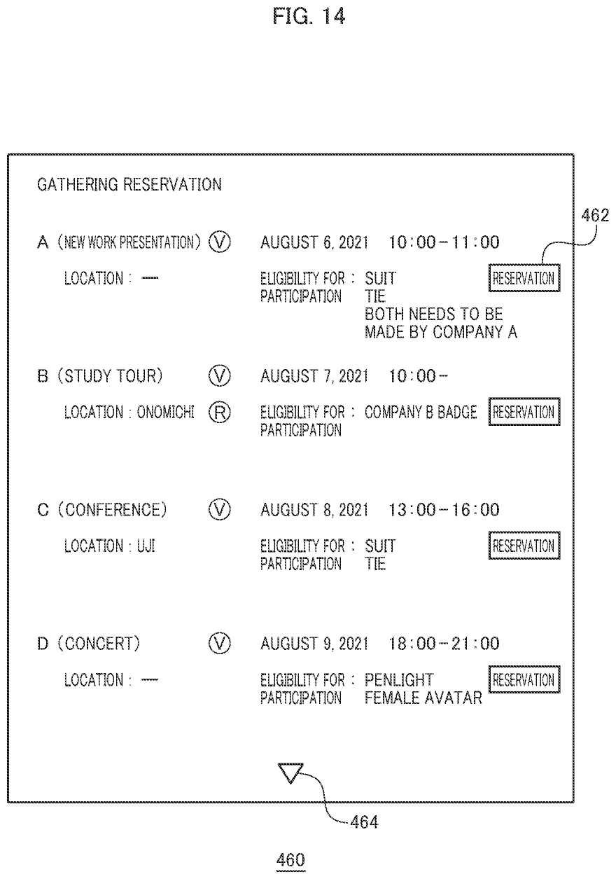

FIG. 14 is a screen diagram illustrating a virtual gathering reservation screen 460.

The user receives the event details of virtual gathering by accessing the gathering server 400. The output unit 312 displays the virtual gathering reservation screen 460 on the screen according to the event details. The event details include the organizer of the virtual gathering, the date and time of the gathering, the location of the gathering, and the eligibility for participation.

As shown in FIG. 14, various types of virtual gatherings are scheduled, such as “New work presentation” by Company A, “Study tour” by Company B, “Conference” by Company C, and “Concert” by Company D. FIG. 14 shows the event details for the four types of virtual gatherings. The user can touch a scroll button 464 to view the event details for another virtual gathering. The user makes a reservation for participation in a virtual gathering on the virtual gathering reservation screen 460.

Company A's new release gathering (hereafter referred to as “Virtual Gathering A”) is labeled only with the “V (virtual)” mark. This means that Virtual Gathering A will be held only in the virtual space (gathering space) and that Real Gathering A will not be held simultaneously.

The date and time of Virtual Gathering A is “10:00 to 11:00 on Aug. 6, 2021,” and no location is designated. Therefore, participants of Virtual Gathering A can participate in Virtual Gathering A by accessing the gathering server 400 before the date and time of the gathering. At Virtual Gathering A, new items of Company A are announced. The new item may be an item object (virtual item) that can be used by avatars in the virtual space or a real item that can be used by users in the real space.

The eligibility for participation in Virtual Gathering A is to have the avatar wear a suit and tie made by Company A. In other words, User P1 needs to have his/her Avatar (P1) wear a suit and tie made by Company A in order for his/her Avatar (P1) to participate in Virtual Gathering A. When the user wants to participate in Virtual Gathering A, he/she makes a reservation by touching the reservation button 462.

When User P1 touches the reservation button 462, the transmission unit 314 transmits the user ID and the ID of Virtual Gathering A to the gathering server 400. The reservation processing unit 424 of the gathering server 400 registers the user ID and Virtual Gathering A in association with each other. By this control method, User P1 is registered as a scheduled participant of Virtual Gathering A. The reservation processing unit 424 sends electronic data representing the reservation ticket to the user terminal 300. The avatar of User P1 (P1) holds the reservation ticket for Virtual Gathering A. In summary, User P1 can have Avatar (P1) participate in Virtual Gathering A by making a reservation for participation in Virtual Gathering A and by dressing up Avatar (P1) to satisfy the eligibility for participation in Virtual Gathering A.

Virtual Gathering B is a study tour hosted by Company B. The location of Virtual Gathering B is “Onomichi.” Virtual Gathering B is labeled with the V mark and the “R (Real)” mark. In other words, while Real Gathering B is held in real Onomichi, Virtual Gathering B is also held in virtual Onomichi in a virtual space. In other words, Virtual Gathering B and Real Gathering B are held simultaneously.

The eligibility for participation in Virtual Gathering B is to have the avatar wear a Company B badge. User P1 first makes his/her Avatar (P1) wear the Company B badge. Next, User P1 moves to Onomichi in the virtual space by a virtual passenger airplane by the date and time of Virtual Gathering B and participates in Virtual Gathering B. User P1 may actually travel to Onomichi (real location) to participate in Real Gathering B. In this way, User P1 may participate in Real Gathering B and Avatar (P1) may participate in Virtual Gathering B. The linkage between the virtual gathering and the real gathering is described below.

Virtual Gathering C is a conference hosted by Company C. The location of Virtual Gathering C is “Uji.” Since Virtual Gathering C is labeled only with the V mark, Real Gathering C is not held. Users need to arrive at virtual Uji by a virtual passenger airplane in time for Virtual Gathering C to be held.

The eligibility for participation in Virtual Gathering C is to wear a suit and tie. In other words, User P1 cannot participate in Virtual Gathering C unless Avatar (P1) wears a suit and tie, although no brand name is designated. When a user requests to participate in a virtual gathering, the registration processing unit 422 determines whether or not the avatar is eligible to participate based on whether or not the avatar satisfies the eligibility requirements.

Virtual Gathering D is a concert hosted by Company D. In Virtual Gathering D, participants can enjoy an artist avatar singing and performing. The artist avatar sings in the voice of the artist. Participants can listen to the singing voice of the artist avatar in the gathering space. Since the location of Virtual Gathering D is not designated, users can participate in Virtual Gathering D by accessing the gathering server 400 on the date and time of the gathering. Again, the registration processing unit 422 checks the eligibility for participation.

The eligibility requirements for participation in Virtual Gathering D are to bring a penlight and to be a female avatar. Therefore, the user needs to have the avatar bring a penlight. In Virtual Gathering D, the participant avatars sway their penlights to the music to create a sense of unity. In addition, the users themselves may be male, but their avatars need to be female. The Virtual Gathering D is a women-only concert, or more strictly speaking, a concert for female avatars only.

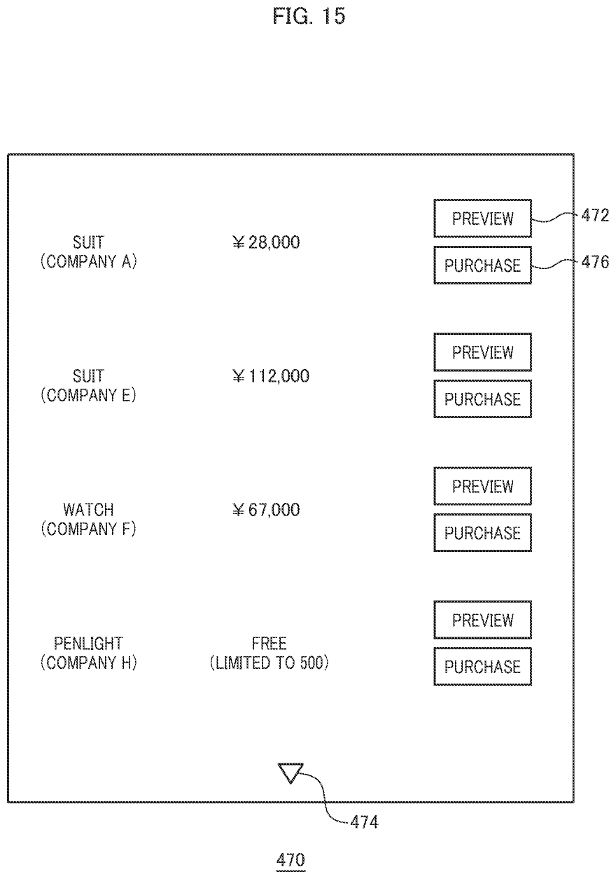

FIG. 15 is a screen diagram illustrating an item purchase screen 470.

The user receives a list of item objects by accessing the gathering server 400. The list of item objects (to be received) is provided by the designated item processing unit 438. The output unit 312 displays the item purchase screen 470 according to the list of item objects provided by the designated item processing unit 438.

In FIG. 15, various virtual items are displayed, such as a “suit” provided by Company A, a “suit” provided by Company E, a “watch” provided by Company F, and a “penlight” provided by Company H. Although four different item objects are displayed on the item purchase screen 470 in FIG. 15, the user can touch the scroll button 474 to view another item object.

The suit (Company A) is sold at a price of “28,000 yen.” When the user touches the preview button 472, the designated item processing unit 438 sends the three-dimensional image of the suit A to the user terminal 300, and the output unit 312 displays the three-dimensional image of the suit (Company A). The user considers whether or not to purchase the suit (Company A) while viewing the three-dimensional image of the suit (Company A).

When User P1 touches the purchase button 476, the transmission unit 314 transmits a purchase instruction including the user ID and the item ID to the gathering server 400. The designated item processing unit 438 registers this user P1 (user ID) and the suit (Company A) in association with each other. Thus, Avatar (P1) can wear the suit (Company A) at any time. The designated item processing unit 438 instructs the payment processing unit 440 to settle the payment for the suit (Company A) to the bank account of User P1. The payment is transferred to the bank account of Company A.

As described above, the avatar needs to wear the suit of Company A in order to participate in Virtual Gathering A. Therefore, if User P1 wants to participate in Virtual Gathering A, he/she needs to purchase a suit (Company A) on the item purchase screen 470 before Virtual Gathering A is held. Company A registers the suit (item object) with the gathering server 400 in advance. By holding an attractive Virtual Gathering A, Company A can earn revenue through the item object, the avatar suit. The user selects a suit (Company A) from the item objects (adornments) owned by the user according to the wearing instructions and participates in the Virtual Gathering A.

Only avatars wearing a suit made by Company A can participate in Virtual Gathering A. By creating commonality and uniformity in the avatar appearance, participants in Virtual Gathering A can enjoy a sense of unity in the venue. In addition, by having avatars wear different suits made by Company A, avatars can enjoy the fun of competing with each other in the fashion sense.

Item objects may be free of charge. For example, the penlight (Company H) shown in FIG. 15 may be purchased (acquired) for free. Furthermore, the penlight (Company H) may be limited to a total of 500 pieces. In this way, an item object (virtual item) may have a limit on the number of units in inventory. The designated item processing unit 438 counts the number of penlights (item objects) sold, and when 500 penlights have been sold, the item can be considered sold out. Setting a limit on the number of item objects in inventory increases the value of the item object.

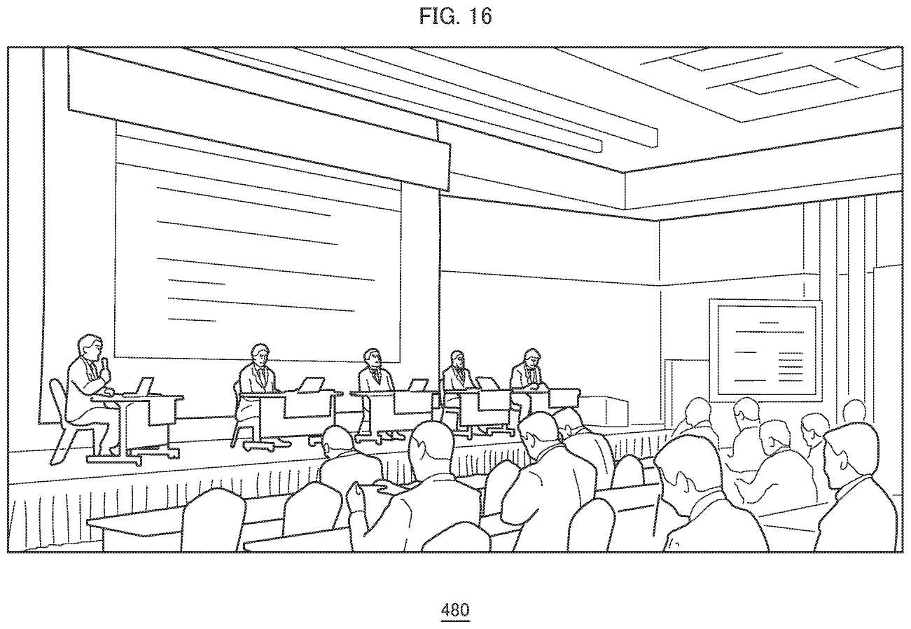

FIG. 16 is a screen diagram illustrating a gathering space 480.

A user who has made a reservation to participate in a virtual gathering logs into the gathering server 400 before the date and time of the virtual gathering. When the location of the virtual gathering is designated, the avatar needs to be moved to the virtual gathering location by a virtual passenger airplane. Once permission to participate has been granted by the registration processing unit 422, the avatar may enter the gathering space 480. Advertising images may be pasted to the walls of the gathering space 480. The gathering experience provision unit 428 transmits a three-dimensional image of the gathering space 480 to the user terminals 300 of the participants. The user can move around the gathering space 480 by controlling the user's own avatar. Many other avatars also exist in the gathering space 480. The user can talk with the other avatars via text chat.

For example, the eligibility for participation in Virtual Gathering C is to have the avatar wear a suit and tie (see FIG. 14). Therefore, many avatars wearing the suits and ties move around in the gathering space 480. The user controls the user's own avatar to move to an empty seat and take the seat. At the time of the gathering, Virtual Gathering C is held. In the gathering space 480 shown in FIG. 16, a discussion begins among the avatar of the moderator and multiple panelist avatars. By providing the gathering space 480 to each user terminal 300, the gathering experience provision unit 428 allows approximately several dozen users to share the same gathering experience at the same time of day in the same gathering space 480.

As in the first embodiment, users can have text conversations with the other avatars on the conversation screen (not shown). The conversation processing unit 220 relays the conversation between avatars. Users may also talk with other users by voice through input/output devices such as microphones and earphones.

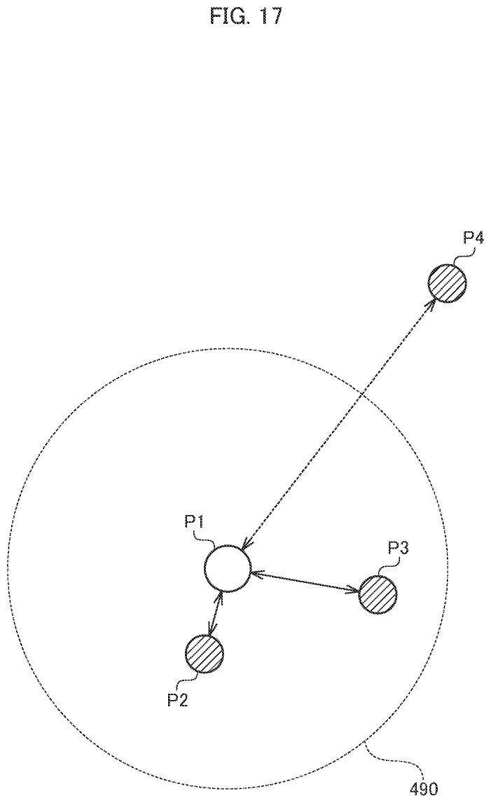

FIG. 17 is a schematic diagram illustrating a talkable range between avatars.

Assume that Avatar (P1) is the user's own avatar and Avatars (P2) through (P4) are the other avatars. The conversation processing unit 426 sets the talkable range 490 centered on Avatar (P1). Here is an example of a voice conversation. When User P1 speaks, the conversation processing unit 426 sends the speech to Avatar (P2) and Avatar (P3), or in other words, to user terminals 300 of Users P2 and P3, who are within the talkable range 490 for Avatar (P1). The output unit 312 of the user terminal 300 of Users P2 and P3 outputs the speech sound. On the contrary, no speech sound is sent to Avatar (P4), who is outside the talkable range 490, or in other words, to the user terminal 300 of User P4.

Thus, the speech of User P1 is transmitted to Users P2 and P3 but not to the user outside the talkable range 490 (Avatar P4). Similarly, the speech of Users P2 and P3 is transmitted to User P1, but the speech of User P4 is not transmitted to User P1. Thus, User P1 can only talk with the other avatars (others) who are near user's own avatar in the gathering space 480.

In the gathering space 480, the avatars of the moderator and panelists hold microphone objects. The conversation processing unit 426 transmits the voice of the avatar (user) holding the microphone object to all avatars (users) in the gathering space 480. Therefore, when a general participant and a panelist have a question and answer session in a virtual gathering, it is necessary to pass the microphone object to the avatar of the general participant, just as in a real gathering. Participants can receive the microphone object when they request permission to speak and are nominated by the moderator.

The same is true for text communication instead of voice communication. That is, when User P1 speaks, the conversation processing unit 426 sends the speech text to Users P2 and P3. The output unit 312 of the user terminal 300 of Users P2 and P3 displays the speech text on the screen. When Avatar P1 holds a microphone object, the conversation processing unit 426 transmits the speech text of Avatar P1 to all participants in the gathering space 480.

FIG. 18 is a schematic diagram illustrating how to hold a virtual gathering 498 and the real gathering 402 simultaneously.

The real gathering 402 is a normal gathering held by real people at a real venue. A huge monitor 492, a speaker 494, and a sound collection microphone 496 are installed at the venue of the real gathering 402. When an avatar with a microphone object speaks in the virtual gathering 498, the conversation processing unit 426 causes the speech sound to be output from the speaker 494 of the real gathering 402. When an avatar makes a comment by text input, as well, the conversation processing unit 426 may output the comment of the speaker 494 as a voice output by using a speech reading function. Meanwhile, the sound of the real gathering 402 is collected by the sound collection microphone 496, and the conversation processing unit 426 transmits the sound of the real gathering 402 to each user terminal 300 participating in the virtual gathering. The gathering experience provision unit 428 may also display images of the gathering space 480 on the monitor 492 and display images of the real gathering 402 to the user terminals 300 participating in the virtual gathering 498.

Since the audio of one of the virtual gathering 498 and the real gathering 402 is transmitted to the other, even the participants of the virtual gathering 498 can have a sense of unity with the real gathering 402. Similarly, the participants of the real gathering 402 can feel the presence of the participants of the virtual gathering 498 through the monitor 492 and the speaker 494.

The participants of the real gathering 402 may be given headsets with an audio output function. In this case, the conversation processing unit 426 may have the speech sound in the virtual gathering 498 output from each headset of the participants of the real gathering 402.

### SUMMARY

The virtual airline service system 100 and the virtual gathering system 404 have been described above based on the embodiments.

In the first embodiment, a large number of users can share the virtual space as a three-dimensional model provided by the airline management server 200 via avatars. The airline management server 200 may provide images of the virtual space as three-dimensional images. Users can also enjoy a more immersive experience in the virtual space by using VR goggles or other communication terminals that allow stereoscopic viewing.

The virtual travel shown in the first embodiment is designed to be easier and more enjoyable than real travel but requires a certain amount of “effort” on the part of the user, such as ticket purchase, boarding procedures, and the 20-minute flight. By making the user go through such efforts, the user is provided with the emotional experience unique to travel, such as the efforts involved in traveling and the extraordinary experience of overcoming such efforts.

In particular, the virtual passenger airplane in the first embodiment has a flight schedule similar to that of a real passenger airplane. The user decides the travel itinerary according to the flight schedule. The virtual passenger airplane can make multiple users feel like they are sharing the same place and time by setting the flight schedule. In other words, multiple users who are not physically present at the same location can have a sense of “shared place.” Thus, even people living in remote areas can enjoy the feeling of traveling together on a virtual passenger airplane. The virtual airline service system 100 makes travel more accessible.

The virtual store allows store operators to expand profit-earning opportunities. In addition, item offerings or advertisements can increase item recognition opportunities. Users can use the avatar to purchase a variety of items through in-flight sales on virtual passenger airplanes or by shopping in virtual stores.

Online shopping is difficult for the elderly, who are not accustomed to using computers. In addition, for vendors who sell items unique to Hokkaido, simply offering their items on the Internet can cause brand damage. There is also a value protected because the items are regional items that can be purchased only in Hokkaido. In the first embodiment, users can select and purchase items with the same feeling as real shopping, while moving their avatars in virtual stores at the virtual New Chitose Airport or the like, after taking the time and effort to travel to Hokkaido by virtual passenger airplane. Users recognize the items in Hokkaido as “bought on the travel” or “only available on the travel,” making it easier to maintain the branding of the items. The virtual airline service system 100 ensures the scarcity of various items while expanding their revenue opportunities.

Compared to real stores, virtual stores have lower operating costs, so there is potential for lower or no fees to open a store. Even small stores that are only known in some parts of Hokkaido and do not have the resources to open a real airport store at New Chitose Airport will find it easier to open a virtual store. Through virtual stores, it becomes easier to deliver Hokkaido's attractions, which are not generally known to the general public, to a large number of users.

The virtual airline service system 100 allows users to travel to a virtual Hokkaido more easily than in reality. By experiencing Hokkaido virtually, users may want to visit the real Hokkaido. Through the experience provided by the virtual airline service, it is possible to boost demand for travel.

Even tourist spots that are less famous than Hokkaido may be able to increase their awareness through virtual travel. For example, Akita City has fewer tourists than Sapporo City; however, by providing a tourist experience in Akita City through the virtual airline service system 100, more users can be made aware of the attractions of Akita City. In addition, providing a tourist experience through the virtual airline service system 100, especially to foreigners who are unfamiliar with Japan, is expected to contribute to an increase in the number of tourists visiting Japan as well as to an increase in the percentage of repeat visitors.

In the second embodiment, a large number of users can share the virtual space as a three-dimensional model provided by the gathering server 400 via avatars. The gathering server 400 may provide images of the virtual space as three-dimensional images.

By having avatars participate in a virtual gathering with a fixed schedule, users can feel a sense of unity with the other avatars and a sense of sharing time and place at the virtual gathering. In addition, by setting eligibility requirements for participation in virtual gatherings, it is possible to create commonality among participants. For example, by setting participation eligibility for avatars, such as having the same adornments, only female avatars, only child avatars, and the like, it is possible to create a unique atmosphere for the avatars who gather at the virtual gathering.

In the virtual space, users can talk with other avatars. In real space, it is difficult to talk to strangers, but in virtual space, avatars serve as masks, making it easier to talk to strangers. In addition, since the conversation processing unit 426 controls the avatars so that their comments are not transmitted outside the talkable range 490, private conversations between avatars are less likely to bother other avatars. The talkable range 490 is a “private conversation space,” so to speak, and has the effect of encouraging conversation among avatars.

Encouraging avatars to wear item objects as adornments as eligibility for participation in a virtual gathering makes the virtual gathering a profit-making opportunity for the organizer. Users can also enjoy virtual gathering by dressing up their avatars. Furthermore, by combining virtual travel and virtual gathering, two types of enjoyment, travel and gathering, can be provided to users. For example, in a case of holding a matchmaking party (virtual gathering) in Honolulu (virtual), incorporating sightseeing in Honolulu (tourist experience) into the schedule makes it easier for users to feel closer to each other.

In the second embodiment, the real and virtual gatherings can be held simultaneously. By relaying audio or video of the real gathering to the virtual gathering and relaying audio or video of the virtual gathering to the real gathering, the participants of the real gathering and the virtual gathering can be made aware of the presence of both. In addition, by holding simultaneous gatherings in both the real and virtual Onomichi, it is possible to create a sense of “commonality of being in the same place despite the differences between the real and virtual,” which can further unify the gathering.

The present invention is not limited to the embodiments described above and modifications thereof, and any component thereof can be modified and embodied without departing from the scope of the invention. Components described in the embodiments and modifications can be combined as appropriate to form various other embodiments. Some components may be omitted from the components presented in the embodiments and modifications.

Modifications

An information center may be set up at an airport. By moving the avatar to the information center, the airport experience provision unit 226 may send a map of the airport premises to the user terminal 300. Virtual store locations or item lists may be added to the map of the airport premises. Similarly, an information center may be set up at a tourist spot. The tourist experience provision unit 224 may transmit a map of a tourist spot to the user terminal 300. This map may also include information about the virtual stores or tourist spots.

Sightseeing tours may be arranged. For example, a guide character may be prepared at New Chitose Airport, and the guide character may recruit participants for Clock Tower tour. Users who board the virtual passenger airplane may apply to the guide character for a tour, and several users may stroll around Clock Tower following guidance from the guide character. The tourist experience provision unit 224 may have the guide character lead the avatars around the tourist spot.

The flight attendant character 146 may concurrently serve as a guide character. The flight attendant character 146 may disembark from the virtual passenger airplane at New Chitose Airport together with the avatars and guide the passengers directly to Clock Tower or the like.

Users can indicate his/her “approval” of the tourist information or advertisements of tourist spots with a “Like” to tourist information or advertisements. By aggregating the number of “Likes” for each tourist spot or advertisement, it is easier to check the popularity of the tourist spot. In the same way, users may add comments to the tourist guide or advertisement of the tourist spot. This control method will contribute to the development of tourism resources because it will allow the user to know not only the popularity of a tourist spot but also the reasons (expectations and impressions) for that spot.

The user terminal 300 may be a specialized device installed in department stores, Internet cafes, and game centers, among other locations. This device may completely shield the user like a cockpit and tilt the seat to simulate the feeling of acceleration and deceleration during the takeoff and landing of a virtual passenger airplane.

Although the first embodiment was described for domestic travel, it can also be applied to overseas travel. For example, virtual overseas travel may be implemented by reproducing cities such as Dublin and Amsterdam in virtual space.

In the first embodiment, the boarding time of the virtual passenger airplane was explained as 20 minutes. The boarding time of the virtual passenger airplane can be set to any length of time. The boarding time may be set constant regardless of the actual distance, or the boarding time may be changed according to the distance. For example, the boarding time from Haneda Airport to Naha Airport may be set to 30 minutes, and the boarding time from Haneda Airport to Changi International Airport (Singapore) may be set to 1 hour, thereby expressing the flight distance by boarding time.

The mileage management unit 230 may vary the mileage points awarded to the user according to the flight distance or boarding time. For example, mileage management unit 230 may award 10 mileage points for a trip from Haneda Airport to Kyoto Airport and 20 mileage points for a trip from Haneda Airport to Okayama Airport. Similarly, ticket prices may be set based on flight distance.

The user can freely choose an avatar. The airline management server 200 may provide paid items such as avatar clothing and adornments on the avatar selection screen (not shown). The user can freely coordinate the clothing of his/her avatar, which is his/her alter ego. When a paid item is purchased, the payment processing unit 228 executes the payment process. The avatar can take a commemorative photo on a virtual passenger airplane or at a tourist spot. Thus, users can dress up their avatars for a virtual travel and appear in the commemorative photo with a beautiful appearance. In addition, the flight attendant character 146 may talk to the avatar about the avatar's clothing on the virtual passenger airplane. For example, if the flight attendant character 146 compliments the avatar by saying, “That's a cute brooch!” the user is further motivated to coordinate the avatar's outfit.

If necessary, the boarding procedure at the boarding gate may be skipped. For example, upon arrival at Haneda Airport, if the “short-cut boarding instruction” is entered, the boarding processing unit 216 may allow the avatar to board without going through the boarding gate. Similarly, when the user misses the departure time of the virtual passenger airplane, the user may input a “short-cut flight instruction,” and the boarding experience provision unit 222 may move the avatar to New Chitose Airport without going through the virtual passenger airplane. The short-cut boarding instruction or the short-cut flight instruction may be a paid option.

A “teleport area” may be provided at the airport. When an avatar holding a ticket to New Chitose Airport enters the teleport area at Haneda Airport, the boarding processing unit 216 may move the avatar instantaneously to a predetermined area at New Chitose Airport without having the avatar experience boarding.

Similarly, the user may be allowed to move directly to a virtual store in Hokkaido. For example, when a user selects “virtual store X at New Chitose Airport” from the list of virtual stores presented by the airline management server 200, the airport experience provision unit 226 may direct this user's own avatar to virtual store X. The user can enjoy shopping at virtual store X without traveling by a virtual passenger airplane. For virtual store Y located in a tourist spot as well, the tourist experience provision unit 224 may allow the avatar to travel directly. The airline management server 200 may present only virtual stores that the user has visited in the past for selection.

Real and virtual services can be merged by using a real, local guide. For example, a contract is made in advance with a local guide at the (real) Kushiro Washo Ichiba Market. The user moves his/her avatar from the virtual Haneda Airport to the virtual New Chitose Airport, and from the virtual New Chitose Airport to the virtual Kushiro Washo Ichiba Market. A (real) local guide uses a video camera to shop at the real Kushiro Washo Ichiba Market on behalf of the user. The user gives voice instructions to the guide through a headset. The local guide then ships the purchased items to the user at a later date. According to this control method, the user can enjoy the atmosphere of the real Kushiro Washo Ichiba Market through the video camera of the local guide after arriving at the virtual Kushiro Washo Ichiba Market.

In addition to those illustrated in the second embodiment, various eligibilities for participation in a virtual gathering can be envisioned. For example, “having participated in virtual gathering F” may be an eligibility for participation in another virtual gathering G. The registration processing unit 422 manages the participation history of each avatar (user) in the virtual gathering. “Participation in a certain number of virtual gatherings” may be an eligibility for participation in Virtual Gathering H. In addition, “the purchase amount of Company A's adornments (item objects) is at least a predetermined amount” may be an eligibility for participation in Virtual Gathering A. Such a control method enables Company A to hold a virtual meeting limited to its “loyal customers.” It is also possible to give participants a feeling of preferential treatment by holding such a virtual gathering.

In the second embodiment, the user needs to make a reservation before participating in a virtual gathering, but depending on the virtual gathering, a reservation may not be necessary. In other words, users may be able to unofficially join an ongoing virtual gathering.

Users may register as “friends” with each other in advance. For example, when User P1 is registered as a friend of User P2, Avatar (P1) and Avatar (P2) may be able to talk with each other even if the distance between them is large in the virtual space.

An upper limit may be set for the number of participants in a virtual gathering. The organizer may set the maximum number of participants as part of the event details. The registration processing unit 422 counts the number of participants each time it accepts a participant, and once the maximum number of participants is reached, it will not accept any more participants. Alternatively, a limit may be set on the number of reservations, and the reservation processing unit 424 may not accept any more reservations once the maximum number of reservations is reached. In principle, there is no upper limit to the number of avatars because there are no physical restrictions on the venue of a virtual gathering. However, by setting a limit on the number of avatars for each virtual gathering, the organizer can set various scales, from large gatherings to small gatherings, depending on the purpose of the virtual gathering. Also, by setting such a scale, it is possible to achieve the same realism as a real gathering.

The gathering experience provision unit 428 may prepare multiple virtual venues for a virtual gathering in advance. The organizer may select a virtual venue where he/she wishes to hold a virtual gathering and send a request to hold the gathering. The operator of the gathering server 400 may collect a fee for the use of the virtual venue from the organizer. Specifically, when the organizer reserves the virtual venue, the gathering experience provision unit 428 instructs the payment processing unit 440 to collect the usage fee from the bank account of the organizer.

Users may enjoy purchasing item objects from each other. For example, a virtual gathering may be held as a sales event for item objects. The gathering experience provision unit 428 displays a number of item objects in the gathering space. Users can enjoy the experience of purchasing item objects while chatting with each other via text or voice through avatars. Specifically, as described in connection with FIG. 10, the gathering experience provision unit 428 may hold a sales event in a virtual space in the same manner as a virtual store.

At the sales event, a salesclerk avatar can be set up to be controlled by a salesclerk. The salesclerk avatar may be a chatbot. Users can talk with the salesclerk avatar when they have questions about item objects.

In this embodiment, the virtual space is described as being generated by computer graphics. As a modification, the virtual space may be generated by captured images of a real space. For example, a large number of images are acquired in advance at New Chitose Airport by using an all-sky camera (360-degree camera) to capture images of various parts of the airport. The airport experience provision unit 226 may configure the interior space of the virtual New Chitose Airport by using the images of the interior of New Chitose Airport thus obtained. The same applies to experiences of boarding a virtual passenger airplane, the experience of sightseeing at a tourist spot such as the virtual Clock Tower, and the experience of gathering at a virtual gathering.

Images of the real gathering may be captured by a camera, and the gathering experience provision unit 428 may display the captured images of the real gathering on a large monitor (virtual object) installed in the gathering space. More specifically, a virtual object corresponding to the large monitor is installed in the gathering space in advance. In addition, a camera is installed in the real gathering. The gathering experience provision unit 428 pastes (maps) the image taken by the camera (video image of the real gathering) to the screen area of the large monitor of the virtual gathering. This control method allows a user who participates in a virtual gathering as an avatar to view the real space through the large monitor of the virtual gathering and enjoy the feeling as if the real gathering were being broadcast remotely.

In the virtual space, avatars may speak after raising their hand. For example, when User P1 inputs the “raise hand command,” Avatar (P1) raises its hand. When Avatar (P1) raises its hand and is nominated by the moderator avatar or other user, Avatar (P1) acquires the right to speak. The moderator user uses the “select command” to select one of the avatars who raise their hand, thereby nominating a speaker. When Avatar (P1) gets the right to speak, the conversation processing unit 426 forwards the speech of User (P1) to the other avatars in the virtual gathering. At the same time, the conversation processing unit 426 outputs the speech of User (P1) from the speaker 494 of the real gathering. At that time, the conversation processing unit 426 may also display the image of the avatar who has obtained the right to speak on the monitor 492 of the real gathering. Meanwhile, the conversation processing unit 426 forwards the voice of the person who has obtained the right to speak at the real gathering to the user terminal 300 of each user participating in the virtual gathering. An image of the speaker at the real gathering may also be captured by a camera and displayed on the monitor of the virtual gathering.

The method of traveling in virtual space is not limited to the virtual passenger airplane. For example, users may travel in the virtual space by virtual train, virtual car, on foot, roller coaster, and virtual bicycle, among others. For example, a schedule of a virtual vehicle, such as a roller coaster, may be set to depart regularly, such as every five minutes. Alternatively, the virtual vehicle may depart at any time specified by the operator. The registration processing unit 422 may also display the entrance page of the virtual gathering on the user terminal 300, and the user may click on the virtual gathering that he/she plans to attend from this entrance page. Then, the gathering experience provision unit 428 may display an animation of a door opening at the venue of the virtual gathering and lead the user to the venue of the virtual gathering. In this case, the user can immediately participate in the virtual gathering without using a virtual passenger airplane or other means of transportation.

For example, a virtual train may operate between virtual stations according to a predetermined schedule, similar to a virtual passenger airplane. Virtual ships and virtual buses travel through the virtual space in a similar manner. For example, a user can enjoy a bus ride in virtual space by moving the avatar to a virtual bus stop modeled in virtual space and boarding the virtual bus when it arrives.

What is claimed is:

1. A virtual travel system, comprising:
a boarding request reception unit that accepts a boarding request for a vehicle from a communication terminal of a user prior to the departure time of the vehicle;
a boarding processing unit that registers the user who has sent a boarding request for the vehicle as a passenger of the vehicle; and
a boarding experience provision unit that provides a common boarding experience to a plurality of passengers of the vehicle.

2. The virtual travel system according to claim 1, further comprising:
a conversation processing unit that relays conversations among passengers to a plurality of communication terminals owned by the plurality of passengers, wherein
the conversation processing unit relays a conversation between a first passenger and a second passenger in the interior space of the vehicle on the condition that the distance between a first avatar corresponding to the first passenger and a second avatar corresponding to the second passenger is within a predetermined range in the virtual space.

3. The virtual travel system according to claim 1, wherein the boarding experience provision unit displays an attendant character corresponding to a cabin attendant in the virtual space representing the interior space of the vehicle, and provides services to the plurality of passengers by the attendant character.

4. The virtual travel system according to claim 3, wherein the boarding experience provision unit displays an avatar that is a character corresponding to a passenger in a virtual space representing the interior space of the vehicle, and provides a commemorative photo service from the attendant character to the avatar.

5. The virtual travel system according to claim 1, further comprising:
a payment processing unit that executes the payment processing, wherein
the boarding experience provision unit displays an attendant character in the interior space of the vehicle, and
when a passenger selects one of the items presented for purchase by the attendant character, the payment processing unit executes the payment for the purchase of the item.

6. The virtual travel system according to claim 5, wherein
the boarding experience provision unit causes the attendant character to hold a game in the interior space of the vehicle in which a plurality of passengers can participate, and
the payment processing unit instructs the delivery of a prize preliminarily associated with the game to the registered address of the passenger who is the winner of the game.

7. The virtual travel system according to claim 1, wherein
the vehicle is a virtual passenger airplane,
the virtual travel system further comprises a mileage management unit that awards mileage points to passengers of the virtual passenger airplane and manages the mileage points for each user, and
the mileage management unit provides rewards to the user based on the mileage points.

8. The virtual travel system according to claim 1, wherein
the vehicle is a virtual passenger airplane, the virtual travel system further comprises:
an airport experience provision unit that transmits an image of a virtual space representing the premises of the destination airport to the communication terminals of the plurality of passengers when the scheduled arrival time of the virtual passenger airplane is reached; and
a payment processing unit that, when a user instructs to purchase an item object at a virtual store in the premises of the airport, executes a payment process of the user for an item corresponding to the item object, wherein
when executing the payment process for the item, the payment processing unit instructs a store terminal associated with the virtual store to deliver the item to the user who purchased the item.

9. The virtual travel system according to claim 8, further comprising a tourist experience provision unit that transmits an image of a virtual space representing a tourist spot that is preliminarily associated with an airport that is the destination, to a communication terminal of a user who has selected the tourist spot.

10. A communication terminal, comprising:
an input unit that accepts a boarding procedure on the condition that the boarding procedure is performed prior to the departure time of the virtual passenger airplane from the user;
a transmission unit that transmits a boarding request together with a user ID to an external airline management server when the boarding procedure is accepted;
a reception unit that receives an image of a virtual space representing the cabin of the virtual passenger airplane after receiving boarding permission for the virtual passenger airplane from the airline management server; and
a display unit for displaying the image of the virtual space image on a screen, wherein
the display unit displays an avatar, which is a character corresponding to another user who has completed a boarding procedure for the virtual passenger airplane, in the cabin of the virtual passenger airplane.

11. A virtual gathering system, comprising:
a participation request reception unit that refers to a predetermined schedule for a virtual gathering, which is a gathering in a virtual space, and receives a participation request for the virtual gathering from a communication terminal of a user;
a registration processing unit that registers a user who has made a participation request for the virtual gathering as a participant of the virtual gathering; and
a gathering experience provision unit that provides a common gathering experience to a plurality of participants of the virtual gathering, wherein
the registration processing unit registers the user as a participant of the virtual gathering on the condition that the avatar that is a character corresponding to the user satisfies predetermined eligibility for participation in the virtual gathering.

12. The virtual gathering system according to claim 11, further comprising a conversation processing unit that relays conversations among participants to a plurality of communication terminals owned by the plurality of participants.

13. The virtual gathering system according to claim 12, wherein
the conversation processing unit relays the conversation between a first user and a second user on the condition that the distance between the avatar of the first user and the avatar of the second user is within a predetermined range in the virtual space where the virtual gathering is held.

14. The virtual gathering system according to claim 11, wherein the registration processing unit registers the user as a participant of the virtual gathering on the condition that the avatar corresponding to the user is wearing a prescribed adornment.

15. The virtual gathering system according to claim 14, further comprising:
a holding request reception unit that receives a request to hold a virtual gathering from an organizer of a virtual gathering, the request including the holding date and time of the virtual gathering and a designated item, and
a designated item processing unit that notifies a user's communication terminal of an avatar's adornment that is the designated item for the virtual gathering and grants the designated item to the user by receiving an instruction from the user to acquire the designated item.

16. The virtual gathering system according to claim 12, wherein
the virtual gathering is held parallelly and simultaneously with a schedule of a real gathering, which is a gathering in a real space, and
the conversation processing unit relays the voice of the participant of the real gathering to the communication terminal of each participant of the virtual gathering and relays the voice of the participant of the virtual gathering to the venue of the real gathering or the viewing devices owned by the participants of the real gathering.

17. A communication terminal, comprising:
a gathering event details reception unit that receives event details of a virtual gathering including a holding date and time of the virtual gathering and a designated item;
a wearing instruction input unit that accepts a wearing instruction for an avatar owned by a user to wear an adornment as a designated item;
a participation instruction input unit that accepts a request for participation in the virtual gathering;
a transmission unit that, when the participation request is accepted, transmits the participation request together with a user ID to an external gathering server;
an image reception unit that, after receiving participation permission for the virtual gathering from the gathering server, receives an image of a virtual space representing the venue of the virtual gathering; and
a display unit that displays an image of the virtual space on a screen, wherein
the display unit displays an avatar wearing the designated item corresponding to another user in the venue of the virtual gathering.
